(19) United States
(12) Patent Application Publication
(10) Pub. No.: US 2015/0381795 A1
(43) Pub. Date: Dec. 31, 2015

(54) METHOD AND SYSTEM FOR PROVIDING REMOTE MONITORING AND CONTROL OF A BATHING SYSTEM

(71) Applicant: GECKO ALLIANCE GROUP INC., Quebec (CA)

(72) Inventors: Christian BROCHU, Quebec (CA); Jean-Francois MONTPLAISIR, Quebec (CA)

(21) Appl. No.: 14/852,792

(22) Filed: Sep. 14, 2015

Related U.S. Application Data
(63) Continuation of application No. 13/336,513, filed on Dec. 23, 2011.

(51) Int. Cl. H04M 1/725; H04L 12/28; H04W 76/02; H04W 60/00; H04W 4/12; H04W 68/00

(52) U.S. Cl. CPC H04M 1/72533; H04W 4/12; H04W 68/005; H04W 76/023; H04W 76/027; H04W 60/00; H04L 12/283; H04L 12/2818

(57) ABSTRACT

A network-enabled controller for a bathing unit is provided. The controller includes a network interface and a memory storing operational setting information associated with the bathing unit. Through the network interface, the controller connects to a home network and registers and maintains an active communication link with a gateway accessed over a network external to the home network. In response to receipt of a status request originating from a remote client, the controller processes the status request and selectively transmits operational setting information stored in the memory to the remote client. A system for facilitating remote control and monitoring of network-enabled controllers for bathing units is also provided. The system comprises a remote control client executed on a personal computing device, an Internet-based server implementing a gateway and a plurality of controllers, wherein respective active communication links are maintained between the server and the plurality of registered controllers.

### CROSS-REFERENCE TO RELATED APPLICATIONS

The present application is a continuation under 35 USC §120 of U.S. patent application Ser. No. 13/336,513 filed Dec. 23, 2011. The contents of the aforementioned document are incorporated herein by reference.

### FIELD OF THE INVENTION

The present invention relates generally to the field of control systems for bathing systems, and more specifically, to a control system and method configured to provide a user with remote control and monitoring capabilities in connection with a bathing system.

### BACKGROUND

Bathing units, such as spas, typically include various bathing unit components that are used in operating the bathing system. The bathing unit components generally include pumps that circulate water through a piping system, pumps for activating water jets, at least one heating module to heat the water, a filter system, an air blower, an ozone generator, a lighting system, and a control system that activate and manage the various operational settings of the bathing unit components. Other types of bathing units that have similar components include, for instance, whirlpools, hot tubs, bathtubs, therapeutic baths, spas and swimming pools. Most modern bathing systems include a user control interface that is in communication with the bathing unit control system. The user control interface is typically positioned in proximity to the bathing system so that a user of the bathing system may interact with it in order to adjust and control the activation and settings of the various bathing unit components.

Increasingly, it is becoming desirable to provide mechanisms to enable users to remotely monitor and control the operations of bathing units. For example, it is desirable to allow an owner of a spa system, when leaving his or her office after a long day at work, to be able to control his spa system so that when he/she arrives at home, the spa water is at a desired temperature level. In another example, an owner of a spa system may leave his/her residence and inadvertently forget to perform some task in connection with his spa, for example turn off the jets, turn off the lights and/or initiate a filtering function amongst others. The owner may also not remember whether the water temperature, jets, lights or other components were set to a desired level or desired mode of operation before leaving his residence. Without the ability to remotely monitor and control the operations of the spa, the user must wait until he/she returns to his residence in order to verify the status of operation of the spa system and/or perform the required task. This is clearly inconvenient for the owner. It is also desirable to allow an owner of a spa to receive notifications in the event of a malfunctioning of the spa so that the owner may take some steps to prevent situations in which the malfunction may cause some damage if not attended to in a timely manner. For example, in the event of a generalized power failure or when the breaker for the spa trips, a situation may arise when power ceases to be provided to the spa. An interruption in the power supply for a prolonged period of time can have undesirable consequences ranging from minor inconvenience such as less than optimal water cleanliness due to an absence of filtration, to more serious damage, such as some components becoming permanently damaged. For example, in cold climates where temperatures fall below the freezing point of water, the absence of heat and circulating water in the circulation pipes may freeze and cause cracks in the pipes.

Some existing systems provide functionality for allowing for the remote control and monitoring of bathing systems to take place over a local computer network. In this regard, some bathing systems can now be equipped with network interfaces for allowing the bathing system to register with a local network (for example a home network) through a router in order to exchange signals with other devices in the same local network. In such a local network, each device is associated with its own internal or private IP address, which allows the devices in the local network to communication with one another through the router. Such a configuration therefore enables a computing device connected to the local network and equipped with suitable software to issue commands to and receive status information from the over the private network through the router.

While connecting a bathing unit system to a local network through a router allows devices connected to a same local network to communicate with one another and thus enables a computing device equipped with suitable software to control and monitor the bathing unit system connected to the same local network, the router typically does not permit devices external to the local network, for example a device on a public network (e.g. the INTERNET), to initiate a communication directly with the bathing unit system in the local network.

Allowing a networked bathing system to be controlled by a device outside the local network of which it is part while preserving a suitable level of security presents a challenge. While internal or private IP addresses within a local or home network are known to the other components in the local (or home) network, these internal or private IP addresses are not known on the public network (the Internet). Rather, the router in the local network will typically implement a network address translator (NAT) mechanism whereby the IP address space of the local network, consisting of private IP addresses, is “hidden” behind a single IP address in another (usually public) address space (e.g. the INTERNET). The single IP address will typically be assigned by an Internet service provider. As a result, devices outside the local network cannot directly communicate with devices within the network but rather communicate through a router. Typically, for security reasons, the local network is configured to enable communication through the router only when the exchange originates in the local network. For example, a bathing unit controller software application running on a smart-phone which is connected to the local network can initiate a communication with a network-enabled bathing system connected the same network and issue commands to the network-enabled bathing system using the private addresses stored on the router. However the same bathing unit controller software application running on the same smart-phone but which is not connected to the local network would only have access to the public address of the local network. Since the communication would originate from the smart phone and this outside the local network, the router would not enable the communication to take place to the bathing system.

One approach for addressing the above issue and for allowing devices on the Internet to control network-enabled bathing system is to assign to the bathing system is own public IP address, which would allow it to communicate directly with other devices on the Internet and thus by-pass the network address translator (NAT) mechanism provided by a router. A deficiency of such an approach is that it requires the owner of the bathing system to maintain a dedicated public IP address for the bathing system, which would attract additional costs for operating the bathing system.

Another approach is to make the bathing system part of a demilitarized zone (DMZ) on the local network and essentially make, which would allow it to communicate directly with other devices on the Internet and thus by-pass the network address translator (NAT) mechanism provided by a router. A deficiency of such an approach is that it creates a security concern since the firewall functionality typically provided by the router would no longer be effective (since it is by-passed) leaving the bathing system susceptible of being accessed by unauthorized third parties.

Another approach for addressing the above issue and for allowing devices on the Internet to control network-enabled bathing system is to make use of a web-server located on the Internet. In such a configuration, the bathing system and the remote control client are linked through a web-server, which acts as an asynchronous mediator between the bathing system and the remote control client. The bathing system periodically sends the web-server bathing unit related information which it wishes to makes available to a remote control device. Such bathing unit related information may include, for example, water temperature settings and operational settings of the various components. The bathing unit related information is in turn stored and analyzed at the web server. The bathing system is also configured to send periodic inquiries as to whether a command for affecting a change in operation is stored at the web server. The web-server is configured such as to be responsive to requests originating from a remote control client for transmitting bathing unit related information stored at the web-server to the remote control client. The web-server is also configured to receive and store commands originating from a remote control client in connection with a specific bathing system. The web-server is configured such as to be responsive to requests originating from a bathing system for transmitting commands to the bathing system. The web server can also be configured to manage a credentials databank to control the access by remote control clients with regards to specific bathing systems by way of logins and passwords.

A deficiency with systems of the type described is that the use of an intermediary web-server introduces undesirable delays in the communication between the bathing system and the remote control client. In particular, such a configuration requires each one of the remote control client and the network-enabled bathing system to periodically issue inquiries to find out if the other entities made any changes to the status information and/or issued any new commands. As a result, in connection with status information, there is an inherent delay between the time the information is sent by the bathing system and stored on the web-server and the time the remote control client accesses the web-server to obtain the status information. Similarly, there is a delay between the time a command is sent by the remote control client and stored on the web-server and the bathing system accessing the web-server to find out of any new commands that have been issued.

Against the background described above, there remains a need in the industry to provide a system and method for providing a user with remote control and monitoring capabilities in connection with a bathing system that alleviates at least in part the problems associated with existing systems and methods.

### SUMMARY

In accordance with a first aspect, the invention provides a network-enabled controller for a bathing unit. The network-enabled controller comprises a network interface and a memory storing operational settings information associated with the bathing unit, the operational settings information including water temperature settings. The network-enabled controller further comprises a processor in communication with the network interface and the memory. The processor is programmed for connecting to a home network through the network interface. The processor is also programmed for registering with a gateway, the gateway being accessed over a network external to the home network, wherein registering with the gateway includes transmitting information identifying the network-enabled controller. The processor is also programmed for maintaining an active communication link between the network-enabled controller and the gateway. In response to receipt of a status request originating from a remote control client, processor is programmed for processing the status request and selectively transmitting through the gateway at least part of the operational settings information stored in the memory to the remote control client.

In specific examples of implementation, the network external to the home network over which the gateway is accessed is the Internet.

In a specific implementation, the processor connecting to the home network through the network interface includes establishing a communication link with a home router and acquiring for the network-enabled controller a private network address from the home router. The processor registering with the gateway includes establishing a communication link with the gateway through the home router and causing the gateway a public network address associated with the network-enabled controller. In non-limiting examples of implementation, the information identifying the network-enabled controller transmitted to the gateway during registration may include an identifier associated with the network-enabled controller (for example “GECKO_SPA#1234”), the media access control (MAC) address of the network-enabled controller or any other information allowing to identify the network-enabled controller amongst other network-enabled controllers.

In a specific implementation, the home router implements a network address translator (NAT) protocol and the gateway includes a server programmed for implementing a STUN protocol for obtaining the public network address associated with the network-enabled controller. STUN is an acronym for referring to a Simple traversal of User Datagram Protocol (UDP) through Network address translators (NATs).

In a non-limiting example of implementation, the public network address associated with the network-enabled controller includes an IP address component associated with the home router and a port identifier component associated with the network-enabled controller.

In specific examples of implementation, the processor of the network-enabled controller maintains the active communication link with the gateway at least in part by transmitting multiple signals to the gateway, the signals being transmitted over time at certain time intervals. The time intervals between transmissions may be the same or may vary according to various criteria. In a non-limiting example, a time delay between two consecutive signals sent to the gateway is at most one minute.

In specific examples of implementation the processor of the network-enabled controller is programmed for processing various messages originating from the remote control client. Such messages may include for example status request messages for obtaining information related to operational parameters of the spa and commands for modifying one or more operational parameters of the spa. Optionally, the processor of the network-enabled controller may be programmed for performing an authentication of the remote control client at least in part by processing the messages received from the remote control client at the network-enabled controller. In such cases, the processor may be programmed for selectively taking an action corresponding to the message received in dependence on results obtained by performing the authentication of the remote control client from which the received message originated. Such authentication allows limiting monitoring and/or control capabilities to certain specific remote control client and/or users and prevents other remote control client and/or users from controlling and/or obtaining information associated with the network-enabled controller. In an alternate implementation, authentication functionality may be omitted from the network-enabled controller and be performed at the gateway. In such alternate implementations, the gateway would selectively forward a given message to the network-enabled controller in dependence on results obtained by performing the authentication of the remote control client.

In specific examples of implementation, the remote control client may be operating on a network-enabled personal computing device such as a smart phone, a computer tablet or a personal computer for example.

In specific implementations, any suitable method may be used for authenticating the remote control client. Such methods may be based on a password, a machine identifier, an IP address or any other suitable mechanism. In a first specific implementation, authentication of the remote control client may be performed on the basis of a password provided by a user of the personal computing device. In another specific implementation, authentication of the remote control client may be performed on the basis of an identifier associated with the personal computing device on which the remote control client is operating. In a non-limiting example, the identifier used to authenticate the remote control client is the media access control (MAC) address associated with the remote computing device operating the remote control client. In such situations, the network-enabled controller may store in a memory one or more MAC addresses associated with devices that are authorized to monitor and/or control the network-enabled controller. When a message is received at the network-enabled controller, authentication is performed by comparing the MAC address of the device that sent the message against the MAC addresses stored in the memory of the network-enabled controller. Although the above example has been described using the MAC address of the device that sent the message, it is to be appreciated that any other suitable identifier associated with the device that sent the message may be used to authenticate the remote control client.

In accordance with another aspect, the invention provides a non-transitory computer readable storage medium storing computer-readable instructions for execution by a processor of a network-enabled controller for a bathing unit, the network-enabled controller having a network interface and a memory storing operational settings information associated with the bathing unit, the computer-readable instructions when executing by the processor of the network-enabled controller configuring the network-enabled controller for:
connecting to a home network through the network interface;
registering with a gateway, the gateway being accessed over a network external to the home network, wherein registering with the gateway includes transmitting information identifying the network-enabled controller;
maintaining an active communication link between the network-enabled controller and the gateway;
in response to receipt of a status request originating from a remote control client, processing the status request and selectively transmitting through the gateway at least part of the operational settings information stored in the memory to the remote control client.

In accordance with another aspect, the invention provides an auxiliary device for use with a controller for a bathing unit. The auxiliary device comprises a controller interface for establishing a communication link with the controller of the bathing unit and a memory storing operational settings information received over the controller interface and associated with the bathing unit, the operational settings information including water temperature settings. The auxiliary device also comprises a network interface and a processor in communication with the network interface, the controller interface and the memory. The processor is programmed for:
connecting to a home network through the network interface;
registering with a gateway, the gateway being accessed over a network external to the home network, wherein registering with the gateway includes transmitting information identifying the auxiliary device;
maintaining an active communication link between the auxiliary device and the gateway;
in response to receipt of a status request originating from a remote control client, processing the status request and selectively transmitting through the gateway at least part of the operational settings information stored in said memory to the remote control client.

In accordance with a specific implementation, the processor is programmed for obtaining operational settings information associated with the bathing unit through the controller interface and for transmitting to the controller through the controller interface commands for controlling bathing unit components in the bathing unit.

In accordance with another aspect, the invention provides an Internet-based server implementing a gateway for enabling control and monitoring of network-enabled controllers for bathing units by remote control clients. The server comprises a processor programmed for maintaining active communication links with a plurality of registered network-enabled controllers for bathing units, at least some of the network-enabled controllers in the plurality of registered network-enabled controllers communicating with the server through respective home routers and being associated with respective public network addresses. In response to receipt of a communication from a specific remote control client, the processor is programmed for identifying a communication link amongst the active communication links maintained with the plurality of registered network-enabled controllers, wherein the identified communication link corresponds to a specific registered network-enabled controller to which the communication is to be directed. The processor is also programmed for directing the communication from the specific remote control client to the specific registered network-enabled controller over the identified communication link.

In a specific example of implementation, the respective home routers implement respective network address translator (NAT) protocols and the processor of the server is programmed for implementing a STUN protocol for obtaining public network addresses associated with the at least some of the network-enabled controllers. STUN is an acronym for referring to a Simple traversal of User Datagram Protocol (UDP) through Network address translators (NATs).

In accordance with specific implementations, the communication from the specific remote control client may convey a status request and/or a command directed to the specific registered network-enabled controller.

In a specific example of implementation, the respective public network addresses associated with the at least some registered network-enabled controllers each include:
an IP address component associated with a home router through which a corresponding network-enabled controller communicates with the Internet-based server; and
a port identifier component associated with the corresponding network-enabled controller.

In a specific example of implementation, the server is further programmed for being responsive to receipt of a registration request from a new network-enabled controller for a bathing unit, the new network-enabled controller being located on a home network and communicating with the server through a corresponding home router, for:
processing the registration request to obtain a public network address associated with the new network-enabled controller; and
maintaining a new active communication link with the new network-enabled controller.

In a specific example of implementation, maintaining an active communication link with a registered network-enabled controller includes receiving multiple signals from the registered network-enabled controller, the signals being received over time at certain time intervals. The time intervals between receptions may be the same or may vary according to various criteria. In a non-limiting example, a time delay between two consecutive signals received at the server from a registered network-enabled controller for which an active communication link is being maintained is at most one minute.

In a specific example of implementation, the processor is programmed for detecting failures associated with the active communication links being maintained with the registered network-enabled controllers. In a specific example of implementation, the processor is programmed for detecting of a failure in an active communication link maintained with a registered network-enabled controller at least in part by detecting an absence of receipt of signals originating from the registered network-enabled controller within a time delay.

In response to detection of a failure of one of the active communication links being maintained with the registered network-enabled controllers, the processor is programmed for initiating a failure advisory process in connection with a registered network-enabled controller corresponding to the active communication link for which the failure was detected. The actions taken in connection with a failure advisory process may vary from one implementation to the other. In a non-limiting example, the failure advisory process may include transmitting a message to a bathing unit service technician identifying the registered network-enabled controller corresponding to the active communication link for which the failure was detected. Alternatively to sending a message to a bathing unit service technician, the failure advisory process includes transmitting a message to the owner of the network-enabled controller corresponding to the active communication link for which the failure was detected advising the owner of the failure. The messages sent to the bathing unit service technician and/or the owner of the bathing unit may for example be in the form of e-mail messages, SMS messages and/or automated telephone messages. In such cases, corresponding e-mail addresses, SMS addresses and/or telephone numbers are stored in a database in association with respective registered network-enabled controllers for which active communication links are to be maintained. It is to be appreciated that any other suitable manner of advising a service technician and/or the owner of the bathing unit of the failure may be used.

In accordance with a specific example, wherein the processor is programmed for performing an authentication of the remote control client and for preventing the communication originating from the specific remote control client from being directed to the specific registered network-enabled controller in dependence on the authentication results. Such authentication allows limiting monitoring and/or control capabilities to certain specific remote control client and/or users and prevents other remote control client and/or users from communication with the specific network-enabled controller. In an alternate implementation, authentication functionality may be omitted from the Internet-based server and be performed at the specific network-enabled controller. In such alternate implementations, the Internet-based server would forward a communication to the specific network-enabled controller without performing an authentication of the remote control client.

In accordance with another aspect, the invention provides a method implemented by an Internet-based server for facilitating control and monitoring of network-enabled controllers for bathing units by remote control clients. The method comprises maintaining active communication links between the Internet-based server and a plurality of registered network-enabled controllers for bathing units. At least some of the network-enabled controllers in the plurality of registered network-enabled controllers communicate with the server through respective home routers and are associated with respective public network addresses. The method also comprises receiving a communication from a specific remote control client. The method also comprises processing the communication received from the specific remote control client to identify a communication link amongst the active communication links being maintained, the identified communication link corresponding to a specific registered network-enabled controller to which the communication is to be directed. The method also comprises directing the communication from the specific remote control client to the specific registered network-enabled controller over the identified communication link.

In accordance with another aspect, the invention provides a non-transitory computer readable storage medium storing program code for execution by an Internet-based server for facilitating control and monitoring of network-enabled controllers for bathing units by remote control clients in accordance with the above described method.

In accordance with another aspect, the invention provides an apparatus for remotely controlling and monitoring a network-enabled controller for a bathing system, the network-enabled controller being connected to a home network through a home router and maintaining an active communication link with an Internet-based server. The apparatus comprises a user interface for exchanging information with a user, a network interface and a processor in communication with the user interface and the network interface. The processor is programmed for issuing a link request to the Internet-based server to enter into communication the network-enabled controller. In response to a successful link acknowledgement received through the Internet-based server, the processor is programmed for entering in a communication relationship with the network-enabled controller and for exchanging messages with the network-enabled controller in accordance with the communication relationship. The processor is also programmed for causing the user interface of the apparatus to visually convey operational settings information associated with the bathing system at least in part based on the messages exchanged with the network-enabled controller, the operational settings information associated with the bathing system including water temperature settings associated with the bathing system.

In specific examples of implementation, the communication relationship entered with the network-enabled controller may be either a peer-to-peer communication relationship or a client-to-server communication relationship.

In a specific example of implementation, the link request sent by the apparatus to the Internet-based server includes information identifying the network-enabled controller with which the apparatus want to enter into communication. The information identifying the network-enabled controller may be a name associated with the network-enabled controller, the media access control (MAC) address associated with the network-enabled controller or any other suitable identifier for identifying a specific network-enabled controller amongst other network-enabled controllers. Optionally, the link request also includes information identifying the apparatus. The information identifying the apparatus may be a name associated with the apparatus, the media access control (MAC) address associated with the apparatus or any other suitable identifier for identifying the apparatus. In a specific example, the information identifying the apparatus may be used to perform authentication on the apparatus.

In specific examples of implementation, the apparatus may be implemented on any suitable personal computing device such as for example, but without being limited to, a smart-phone, a tablet computer or a desktop computer.

In specific implementations, the messages exchanged between the apparatus and the network-enabled controller may include status request messages and command messages originating from the apparatus, the status request message and command messages being transmitted to the network-enabled controller through the Internet-based server. The messages may also include reply messages being transmitted through the Internet-based server and originating from the network-enabled controller, the reply messages conveying the operational settings information associated with the bathing system including the water temperature settings. Alternatively the status request message, command messages and/or reply messages may by-pass the Internet-based server and be exchanged between the apparatus and the network-enabled controller over the public Internet.

In accordance with another aspect, the invention provides a non-transient computer readable storage medium for storing computer executable program code for remotely controlling and monitoring a network-enabled controller for a bathing system, the network-enabled controller being connected to a home network through a home router and maintaining an active communication link through an Internet-based server. When executed by a processor of a computing device, the computer executable program code configures the computing device for issuing a link request to the Internet-based server to enter into communication the network-enabled controller. In response to a successful link acknowledgement received by the computing device through the Internet-based server, the computer executable program code configures the computing device for entering in a communication relationship with the network-enabled controller. The computer executable program code also configures the computing device for exchanging messages with the network-enabled controller in accordance with the communication relationship. The computer executable program code also configures the computing device for causing operational settings information associated with the bathing system to be visually conveyed to a user of the computing device, the operational settings information being derived at least in part based on the messages exchanged with the network-enabled controller through the Internet-based server, the operational settings information including water temperature settings associated with the bathing system.

In accordance with another aspect, the invention provides a system for facilitating control and monitoring of network-enabled controllers for bathing units. The system comprises an Internet-based server implementing a gateway and a plurality of network-enabled controllers registered with the Internet-based server. Respective active communication links are maintained between the Internet-based server and the plurality of registered network-enabled controllers. The system also comprises a remote control client executed on a personal computing device, the remote control client configuring the personal computing device for issuing a communication to the Internet-based server in connection with a specific network-enabled controller. The Internet-based server is responsive to receipt of the communication from the personal computing device for:
i. identifying a communication link amongst the active communication links maintained between the Internet-based server and the plurality of registered network-enabled controllers, the identified communication link corresponding to a specific registered network-enabled controller to which the communication is to be directed;
ii. directing the communication to the specific registered network-enabled controller over the identified communication link.

In accordance with a specific example of implementation, at least one of said plurality of registered network-enabled controllers is part of a home network including a router and communicates with the Internet-based server through the home router.

In accordance with specific examples, the communication from the personal computing device may convey a status request directed to the specific registered network-enabled controller and/or a command for modifying at least one operational parameter associated with a bathing unit controlled by the specific registered network-enabled controller.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 shows a block diagram of a bathing unit system including a network-enabled controller in accordance with a non-limiting example of the present invention;

FIG. 2 shows a simplified block diagram of a system for facilitating remote control and monitoring of the bathing unit system shown in FIG. 1 including a server implementing a gateway in accordance with a non-limiting example of the present invention;

FIG. 3 shows a more detailed block diagram of the server depicted in FIG. 2 in accordance with a non-limiting example of the present invention;

FIG. 4 shows a process implemented by the network-enabled controller of the bathing unit system shown in FIG. 1 for establishing a communication link with the server depicted in FIG. 2 in accordance with a non-limiting example of the present invention;

FIG. 5 is a block diagram of a personal computing device for remotely controlling and monitoring the bathing system depicted in FIG. 1 in accordance with a non-limiting example of the present invention;

FIG. 6 shows a process implemented by the personal computing device depicted in FIG. 5 for establishing a communication link with a network-enabled controller through the server depicted in FIG. 2 in accordance with a non-limiting example of the present invention;

FIG. 7 shows a process implemented by the network-enabled controller of the bathing unit system shown in FIG. 1 for processing a message originating from a remote control client in accordance with a non-limiting example of the present invention;

FIG. 8 shows a block diagram of a system for facilitating control and monitoring of network-enabled controllers for bathing units by remote control clients including a server implementing a gateway in accordance with a non-limiting example of the present invention;

FIG. 9 is a conceptual illustration of an address-translation table stored in a memory of the server of the system shown in FIG. 8 in accordance with a non-limiting example of the present invention;

FIG. 10 is a process implemented by the server of the system shown in FIG. 8 in accordance with a non-limiting example of the present invention;

FIG. 11 is a process implemented by the server of the system shown in FIG. 8 in connection with a communication received from a remote control client in accordance with a non-limiting example of the present invention;

FIG. 12 is another process implemented by the server of the system shown in FIG. 8 in connection with a communication received from a network-enabled controller for a bathing unit in accordance with a non-limiting example of the present invention;

FIG. 13 is another process implemented by the server of the system shown in FIG. 8 for monitoring and detecting failure in communication links being maintained with a plurality of registered network enabled controllers in accordance with a non-limiting example of the present invention;

FIG. 14 is a specific example of a personal computing device implementing a remote control client suitable for use in connection with the system shown in FIG. 8 in accordance with a non-limiting example of the present invention;

FIG. 15 is a block diagram of an auxiliary device for use with a controller for a bathing unit for facilitating the remote control and monitoring of the bathing unit system in accordance with an alternate non-limiting example of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to a specific implementation of the invention in the context of a bathing system. It is to be understood that the term “bathing system”, as used for the purposes of the present description, refers to spas, whirlpools, hot tubs, bathtubs, therapeutic baths, swimming pools and any other type of bathing unit that can be equipped with a control system for controlling various operational settings of the bathing units.

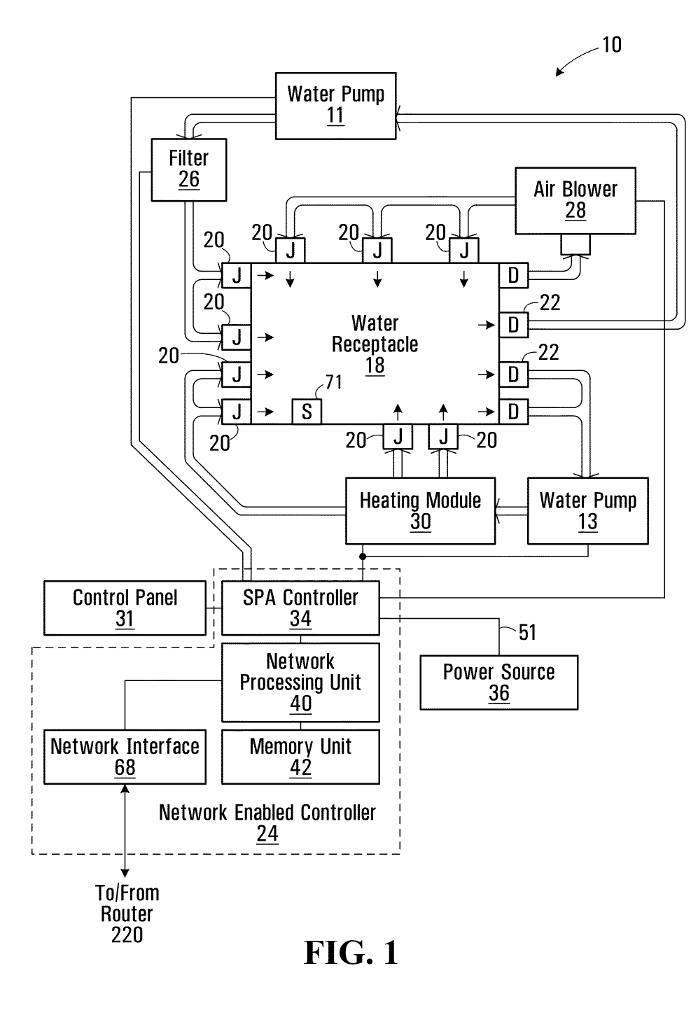

FIG. 1 illustrates a block diagram of a bathing system 10 in accordance with a non-limiting example of implementation of the present invention. The bathing system 10 includes a water receptacle 18 for holding water, a plurality of jets 20, a set of drains 22 and a network-enabled controller 24. In the specific embodiment shown in FIG. 1, the bathing system 10 further includes a set of bathing unit components comprising a heating module 30, two water pumps 11 and 13, a filter 26 and an air blower 28. It should be understood that the bathing system 10 could include more or less bathing unit components without departing from the spirit of the invention. For example, although not shown in FIG. 1, the bathing system 10 could include an ozonator, a lighting system for lighting up the water in the receptacle 18, multimedia devices such as an MP3 player, a CD/DVD player as well as any other suitable device.

In the non-limiting embodiment shown, the network-enabled controller 24 includes a spa functionality controller 34 for controlling the set of bathing unit components 11, 13, 26, 28, 30 and a network processing unit 40 for coordinating interactions between the spa controller and external devices. It is to be appreciated that although in the embodiment illustrated in FIG. 1, the spa functionality controller 34 and the network processing unit 40 are shown as two distinct components of the network-enabled controller 24, they may in alternate examples of implementation be implemented by a same physical processor and be part of the same physical device. The spa functionality controller 34 communicates with a user control panel 31, which enables a user to enter user commands for the spa functionality controller 34. In a specific embodiment, the user control panel 31 comprises a display screen and a user input device (which can also be referred to as a user operable input). The user input device could include a trackball, mouse, gyroscope remote (which senses movement of the device in the air so as to move a cursor), a keypad, a touch sensitive screen, turn-dials, turn-and-push dials (such as idrive from BMW), a stylus pen or a microphone, among other possibilities. The user input device can include one or a combination of any or all of the above input devices.

The user control panel 31 provides an interface that allows a user to enter commands for causing the controller 34 to control the various operational settings of the bathing unit components 11, 13, 26, 28, 30. Some non-limiting examples of operational settings include temperature control settings, jet control settings, and lighting settings, among other possibilities. In a non-limiting embodiment where the bathing unit is connected to entertainment and/or multimedia modules, the operational settings of the bathing unit may also include audio settings and video settings, amongst others. Consequently, the expression “operational settings”, for the purpose of the present invention, is intended to cover operational settings for any suitable bathing unit component or components that can be operated by a user of the bathing system.

In normal operation, water flows from the bathing unit receptacle 18, through the drains 22 and is pumped by water pump 13 through the heating module 30 where the water is heated. The heated water then leaves the heating module 30 and re-enters the bathing unit receptacle 18 through jets 20. In addition, water flows from the bathing unit receptacle 18, through different drains 22 and is pumped by water pump 11 through filter 26. The filtered water then re-enters the bathing unit receptacle 18 through different jets 20. Water can flow through these two cycles continuously while the bathing system 10 is in operation. Optionally, water can also flow from the bathing unit receptacle 18 through one or more drains 22 to an air blower 28 that is operative for delivering air bubbles to water that re-enters the bathing unit receptacle 18 through jets 20.

The network-enabled controller 24 receives electrical power from an electric power source 36 that is connected thereto via service wiring 51. The power source 36 supplies the network-enabled controller 24 with any conventional power service suitable for residential or commercial use. In a non-limiting implementation, the power source 36 can supply 240 volts (V) AC to the network-enabled controller 24 via service wiring 51. In an alternative non-limiting implementation, the power source 36 can supply 120 volts (V) AC to the network-enabled controller 24 via service wiring 51. In yet a further alternative non-limiting implementation, the power source 36 can supply 120 Volts and 240 Volts AC to the network-enabled controller 24 via service wiring 51. It is to be appreciated that other voltage supply values or voltage supply combinations, for example depending on geographical location, are possible without detracting from the spirit and scope of the invention. In a non-limiting implementation, the service wiring 51 is passed through a ground fault circuit interrupter (GFCI) that is adapted for tripping in the presence of a current leakage to the ground. The ground fault circuit interrupter (GFCI) provides an added safety measure to the bathing system.

The spa functionality controller 34 is configured for controlling the distribution of power supplied to the various bathing unit components 11, 13, 26, 28, 30 in order to cause desired operational settings to be implemented on the basis of program instructions and signals received from the user control panel 31 or from a device external to the system 10 through the network processing unit 40. The spa functionality controller 34 may also receive control signals from various sensors 71 in order to cause the desired operational settings to be implemented. Manners in which the spa functionality controller 34 can be used to control the individual bathing unit components of the bathing system, such as for example the jets 20, the drains 22, the heating module 30, the water pumps 11 and 13, the filter 26, the air blower 24, a valve jet sequencer for massage, a variable speed pump with a pre-programmed massage setting, a water fall, an aroma therapy device and an atomizer, as well as any lighting and multimedia components, are well known in the art and are not critical to the invention and as such will not be described in further detail here.

A mentioned above, and as depicted in FIG. 1, the network-enabled controller 24 includes a network processing unit 40 for coordinating interactions between the spa functionality controller 34 and external devices. The network processing unit 40 is in communication with a memory unit 42 and a network interface 68. The network interface 68 may be of any suitable type known in the art including a wireless interface and wired interface. In a non-limiting implementation, the network interface 68 includes a wireless antennae suitable transmitting signal in a WiFi network. The memory unit 42 stores program instructions for execution by the network processing unit 40 for coordinating interactions between spa functionality controller 34 and external devices (not show in FIG. 1).

The memory unit 42 stores program instructions and data for use by the network processing unit 40. The data stored in the memory 42 includes, amongst others, information conveying operational settings associated with components in the bathing unit. For example, the operational settings may include temperature control settings, jet control settings, and lighting settings, among other possibilities. The memory 42 may also store water temperature information conveying water temperature measurements for water in the bathing system. The program instructions stored in the memory unit 42 when executed by the network processing unit 40 provide network related functionality which will be described in greater detail in the present application.

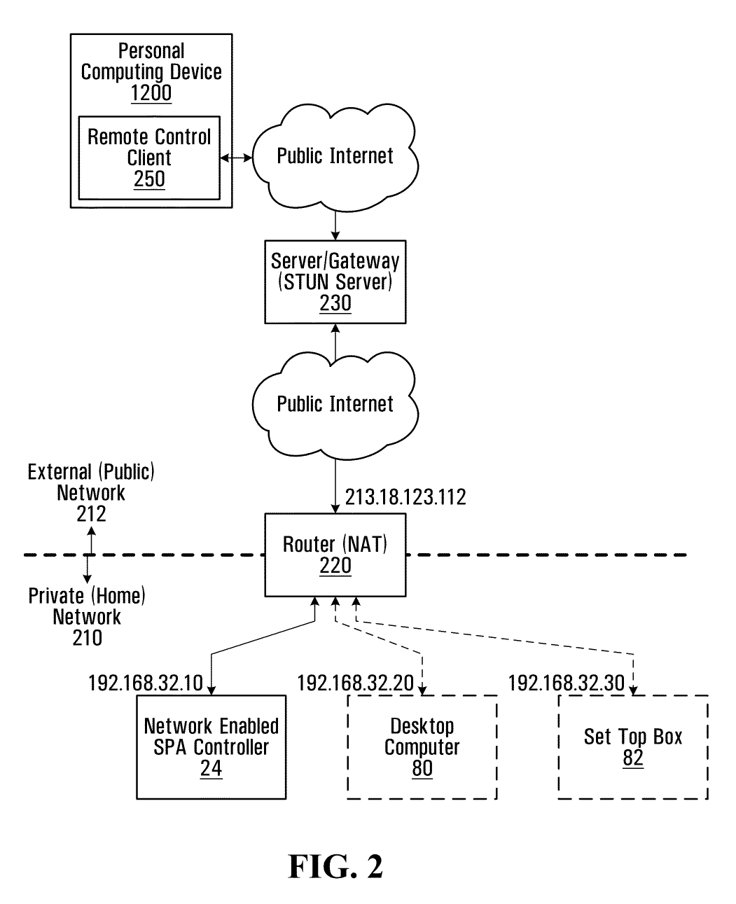

In a specific example, the network-enabled controller 24 is used to facilitate the remote control and monitoring of the bathing system depicted in FIG. 1 in the context of a system of the type shown in FIG. 2. A depicted, the system includes the network-enabled controller 24, a router 220, an Internet accessible server 230 implementing a gateway, and a personal computing device 1200 implementing a remote control client 250. In a non-limiting example the system establishes a TCP or UDP socket type connection between the network-enabled controller 24 and the personal computing device 1200 implementing a remote control client 250 through the Internet accessible server 230. In this manner, the network-enabled controller 24 and the personal computing device 1200 implementing a remote control client 250 can communicate with one another through the Internet accessible server 230 while one or both are in respective private networks. A “Keepalive” type communication can be used in case of an asymmetric network in order to maintain an active communication link between the network-enabled controller 24 and the Internet accessible server 230 and, optionally, between the remote control client 250 and the Internet accessible server 230.

More specifically, in use, the network-enabled controller 24 is in communication with the router 220.

The router 220 includes the necessary functionality for establishing a private (home) network 210 to which different network-enabled devices can connect. Amongst others, the router 220 is configured for assigning to each connected device on the private (home) network 210 a respective private network address that is used for communicating with the router and other devices within the network 210. In the example depicted in FIG. 2, the private (home) network 210 established by router 220 is shown as having three networked devices connected thereto including the network-enabled controller 24, a desktop computer 80 and a set top box 82. It is to be appreciated that the devices other than the network-enabled controller 24 have been shown in FIG. 2 for the purpose of illustration only and that additional or fewer devices may be connected to the private (home) network 210 along with the network-enabled controller 24.

As mentioned, the router 220 is configured to assign to each device a respective private network address that is used within the network 210. The router 220 also acts as an interface for communications between devices within the private (home) network 210 and devices residing on networks outside the private (home) network 210. In connection with such communications, the router 220 implements a network address translator (NAT) mechanism whereby the private network addresses of the devices in the private (home) network 210 are mapped to one public IP/Internet address. The public IP/Internet address will typically be assigned by an Internet service provider. There are different types of NATs that can be implemented by the router such asymmetric Cone, Symmetric Cone, or completely asymmetric. Routers suitable for establishing private (home) networks which provide Network Address Translation (NAT) capabilities are known in the art and will therefore not be described in further detail here.

In use, the network-enabled controller 24 is also in communication with the Internet accessible server 230, which implements a gateway.

The server 230 is associated with a public IP/Internet address and is accessible by the network-enabled controller 24 over the public Internet.

When the network enabled controller 24 establishes a communication with the server 230 through the router 220, the server is programmed for processing that communication to obtain a public network address associated with the network-enabled controller 24. This public network address can then be sent back to the network-enabled controller 24 so that the network-enabled controller 24 is made aware of the public network address that it is using. In a specific example, the public network address associated with the network-enabled controller 24 includes an IP address component associated with the home router 220 and a port identifier component associated with the network-enabled controller 24, wherein the port identifier component was assigned by router 220. Different methods for obtaining the public network address may be used. In a specific practical implementation, the server 230 implements a STUN protocol to obtain the public network address associated with the network-enabled controller 24, wherein the network-enabled controller 24 implements a client portion of the STUN protocol. STUN is an acronym for referring to a Simple traversal of User Datagram Protocol (UDP) through Network address translators (NATs). A STUN protocol allows applications operating through a Network address translator (NAT) to discover the presence of a network address translator and to obtain the mapped (public) IP address (NAT address) and port number that the NAT has allocated for the application's User Datagram Protocol (UDP) connections to remote hosts. STUN techniques have been used in connection with IP telephony (VoIP) for establishing communication links between two secured devices behind respective NATs. The specific manner in which a STUN protocol is implemented may vary from one implementation to the next and is not critical to the present application and therefore will not be described in further detail here. Other techniques for obtaining the public network address associated with the network-enabled controller 24 may also be used in alternative examples of implementation for example Traversal Using Relay NAT (TURN) and Interactive Connectivity Establishment (ICE) could be used. For the purpose of simplicity, the examples presented in the present application will consider the case where a STUN protocol is used by the server 230.

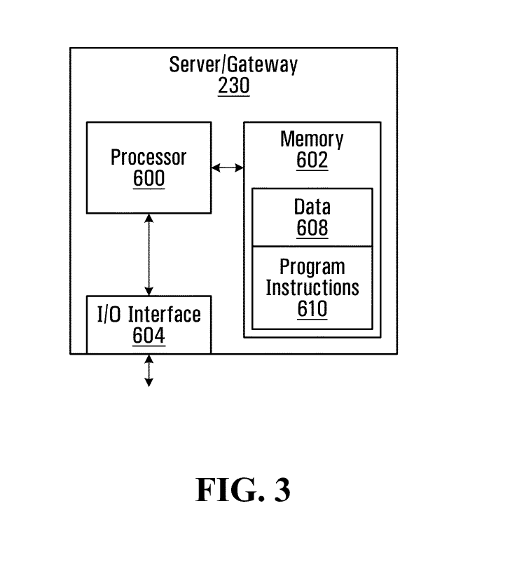

FIG. 3 shows a functional block diagram of the server 230 in accordance with a non-limiting example of the present invention. As shown, the server 230 includes a processor 600 and memory unit 602 connected by a communication bus. The memory unit 602 includes data 608 and program instructions 610. The processor 600 is operative for processing program instructions 610 and data 608 stored in the memory unit 602 for implementing the functionality of the server 230. The server 230 also includes one or more I/O interfaces 604 for communicating with external devices including one or more network-enabled spa controllers, such as network-enabled spa controller 24, and one or more devices implementing remote control clients, such as personal computing device 1200 implementing remote control client 250. It is to be appreciated that although the server 230 has been depicted as a single physical device with a single processor in FIG. 3, in practical implementations server 230 may be implemented by a single physical device with one or more processors or by multiple physical devices each having one or more processors. In the case were the server is implemented by multiple devices, the latter may reside in a same location or in different locations.

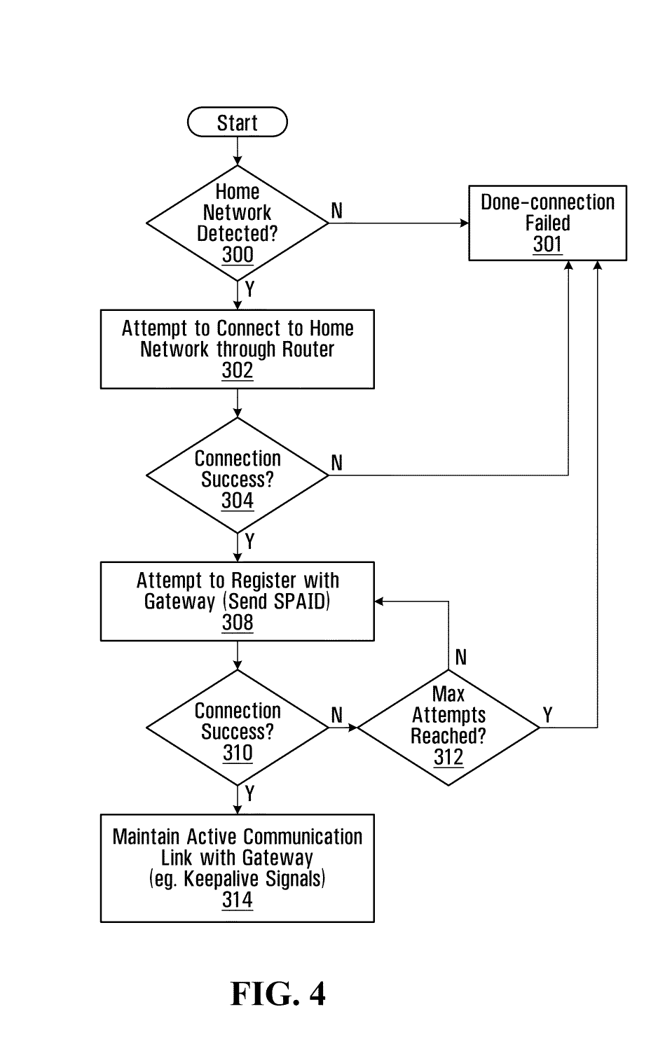

FIG. 4 of the drawings shows a process implemented by the network-enabled controller 24 for establishing a communication link with server 230 through router 220.

As shown, at step 300, the network-enabled controller 24 first attempts to locate a local network. If no network is detected at step 300, the process proceeds to step 301 where it terminates due to a failure in connection. Optionally at step 301, information indicating the reason for the termination, namely that the network-enabled controller 24 failed to locate a local network, is stored in a memory (for example memory 42). Information indicating the reason for the termination can also be conveyed to the user of the bathing system 10 through display means (not shown in the Figures).

If a local network is detected at step 300, which for the purpose of this example is private (home) network 210 (shown in FIG. 2), the process proceeds to step 302 where the network-enabled controller 24 attempts to connect to local network through router 220. The connection includes the router 220 assigning a private network address to the network-enabled controller 24. In FIG. 2, the private network address of network-enabled controller 24 is shown as address “192.168.32.10”. The attempt to connect to the local network through router 220 is effected in accordance with methods known in the art and may include security related functionality, such as providing a pass code or key in situations whether the private network is a secured (encrypted) network. Optionally, the network-enabled spa controller 24 may be configured for, in the absence of detecting a known network, generating an AD HOC network to enable communications with device within range. In such a case, the network-enabled spa controller 24 will act as DHCP server.

At step 304, it is determined whether the connection to the private (home) network 210 succeeded. If at step 304 it is determined that the connection attempt failed, the process proceeds to step 301 where it terminates due to a failure in connection. Optionally at step 301, information indicating the reason for the termination, namely that the network-enabled controller 24 failed to connect to the local network, is stored in a memory (for example memory 42). Information indicating the reason for the termination can also be conveyed to the user of the bathing system 10 through display means (not shown in the Figures).

If at step 304 it is determined that the connection attempt succeeded, the process proceeds to step 308 where the network-enabled controller 24 attempts to register with the server 230. In a specific implementation, in which a STUN protocol is used, the network-enabled controller 24, operating inside private (home) network 210, sends a registration request to server 230 over the public Internet through router 220. Preferably, the registration request includes information identifying the network-enabled controller 24. The information identifying the network-enabled controller 24 may be of any suitable form, including but not limited to the media access control (MAC) address of the network-enabled controller, a serial number, a user assigned character string (e.g. Bob's_spa), a manufacturer assigned character string or any other suitable manner for identifying the network-enabled controller 24. The address of the server 230, preferably in the form of a Uniform Resource Locator (URL) is specified by information stored in the memory unit 42 (shown in FIG. 1) of the network-enabled controller. In transit, when the registration request reaches the router 220, the private network address of network-enabled controller 24, which includes a private IP address component (“192.168.32.10”) and a private (internal) port, are swapped for a public network address, including a public IP address component associated with the home router 220 (shown as “213.18.123.112” in FIG. 2) and an external port component assigned by the router 220 to the transmitted registration request. A modified version of the registration request, including the public network address, is forwarded to the server 230. The server 230 processes the registration request. During the registration process with server 230, a negotiation may be done with network-enabled controller 24 to determine how the network-enabled controller 24 may be reached through router 220 and according to which protocol (e.g. UDP or TCP). A determination may also be made as to whether the communication to the network-enabled controller 24 is UDP “hole punching” ready. Examples of the manner in which the server 230 can process the registration request will be described later on the present specification.

If the registration request fails, the server 230 will either transmit a “failure response” to the network-enabled controller 24 or alternatively will transmit nothing. If either a “failure response” is received by the network-enabled controller 24 or if no response is received after a certain time following the transmission of the registration request to the server 230, step 310 will be answered in the negative and the registration attempt will be considered to have failed. As shown in FIG. 3, the network-enabled controller 24 may make multiple registration attempts 308 until a registration attempt succeeds or until a maximum number of attempts that have failed has been reached. If at step 312 it is determined that a maximum number of attempts that have failed has been reached, the process will proceed to proceeds to step 301 where the process terminates due to a failure in registration with the server 230. Optionally at step 301, information indicating the reason for the termination, namely that the network-enabled controller 24 failed to successfully register with the server 230, is stored in a memory (for example memory 42 shown in FIG. 1). Information indicating the reason for the termination can also be conveyed to the user of the bathing system 10 through display means (not shown in the Figures).

If the registration request succeeds, the server 230 will transmit a “success response” to the network-enabled controller 24. In a specific implementation, the success response will include the public network address associated with the network-enabled controller 24 as observed from the perspective of the server 230. As part of the registration process, the server may also store information mapping the information identifying the network-enabled controller 24 and the public network address associated with the network-enabled controller 24 as observed from the perspective of the server 230. In a specific implementation, the returned public network address associated with the network-enabled controller 24 may include the public IP address component associated with the home router 220 and the port identifier component assigned by the router 220 to the transmitted registration request sent at step 308. If either a “success response” is received by the network-enabled controller 24, step 310 will be answered in the affirmative and the registration attempt will be considered to have succeeded. In such case, the process will proceed to step 314.

At step 314, the network-enabled controller 24 initiates a process to maintain an active communication link with the server 230. In specific practical implementations, when messages are sent through router 220, the private network address of network-enabled controller 24, which may include a private IP address component (“192.168.32.10”) and a private (internal) port, are mapped to a public network address, may include a public IP address component associated with the home router 220 (shown as “213.18.123.112” in FIG. 2) and an external port component assigned by the router 220. However, in typical routers such address mappings are not permanently assigned. Typically, if a specific private/public address mapping affected at router 220 is not used after a particular amount of time (depending on the configuration of router 220), such address private/public mapping is “dropped” by the router 220 and is therefore no longer effective. In order to maintain a specific private/public address mapping, the network-enabled controller 24 maintains an active link with the server 230. An active link may be maintained in a number of manners for example by transmitting multiple signals from the network-enabled controller 24 to server 230 over time. In a non-limiting example, the time delay between two consecutive signals is at most 1 minute. In a specific implementation, at least one packet is sent from the network-enabled controller 24 to the server 230 within the time delay. It is noted that the specific time delay between two consecutive signals may vary from one implementation to the other. In a non-limiting example, a communication of the type “Keepalive” is used to maintain an active communication link between the network-enabled controller 24 and the server 230.

The process depicted in FIG. 4 may be executed by the network processing unit 40 (shown in FIG. 1) on the basis of program instructions stored in the memory 42 (also shown in FIG. 1). A process of the type depicted in FIG. 4 may be initiated on power-up of the network-enabled controller 24 or on the basis of a command provided by the user, either through control panel 31 or though another input device (not shown in the Figures) in communication with network processing unit 40.

As a result of the process illustrated in FIG. 4, an active communication link has been established between the network-enabled controller 24 and the server 230 through router 220 (shown in FIG. 2) and the network-enabled controller 24 has been made aware of its public network address, which may include a public IP address component associated with the home router 220 and an external port component. The network-enabled controller 24 can then use its public network address for communicating with devices outside the private (home) network in accordance with a peer-to-peer communication relationship or in a client-server communication relationship (where the network-enabled controller 24 assumes the role of a server) by sharing its public network address with these devices. In a specific example, at the server 230, a mapping has been created between

In use, in the system depicted in FIG. 2, the network-enabled controller 24 also enters in communication with the personal computing device 1200 implementing the remote control client 250 through the server 230.

The remote control client 250 that is implemented on personal computing device 1200, provides a user with remote access to the network-enabled controller 24 of the bathing system 10. More specifically, the personal computing device 1200 communicates with the network-enabled controller 24 through the server 230 to transmit a signal based on information entered by a user via the remote control client 250. In this manner, a user can provide commands to the network-enabled controller 24 in order to activate and/or modify the operational settings of the bathing unit components without actually having to be in proximity to the bathing unit system. For example, a user may be able to initiate activation of bathing unit components, and/or adjust the operational settings of the bathing unit components, while the user is travelling home from work, such that the bathing system 10 is ready for the user by the time the user gets home.

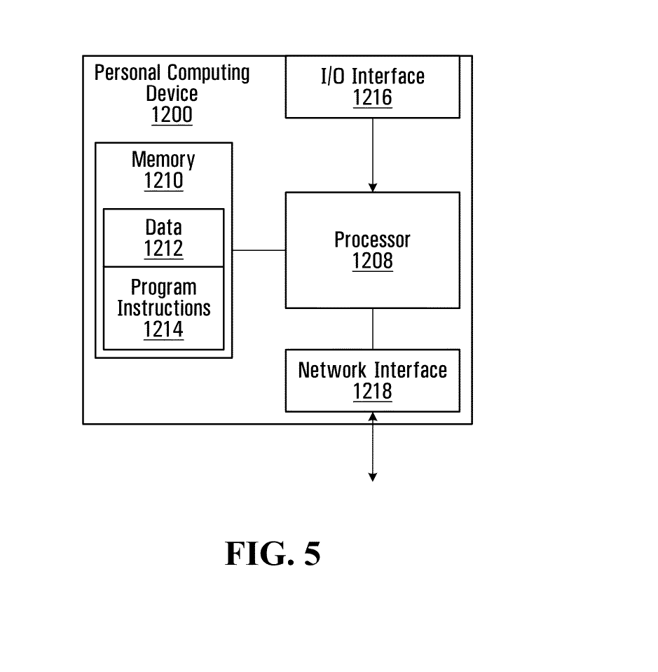

FIG. 5 shows a functional block diagram of the personal computing device 1200 in accordance with a non-limiting example of the present invention. As shown, the personal computing device 1200 includes a processor 1208 and memory unit 1210 connected by a communication bus. The memory unit 1210 includes data 1212 and program instructions 1214. The processor 1208 is operative for processing program instructions 1214 and data 1212 stored in the memory unit 1210 for implementing the functionality of the remote control client 250. The personal computing device 1200 also includes one or more I/O interfaces 1216 for communicating with external devices including but not limited to a display screen and one or more user operable inputs. The personal computing device 1200 also includes a network interface module 1218 for exchanging signals with external devices including the Internet-based server 230.

In practical implementations, the personal computing device 1200 may be embodied as any suitable type of computing device known in the art. For example, the personal computing device 1200 may be a personal computer such as a desktop or laptop computer, or the personal computing device 1200 may be a portable hand-held computing device, such as a PDA, a cell phone, a smart phone (such as a Blackberry™ or an iPhone™), or a web-enabled computing device (such as an iTouch™, iPad™ or computer Tablet), among other possibilities.

The remote control client 250 implemented by the personal computing device 1200 provides amongst other spa control and monitoring functionality. The spa control and monitoring functionality enables a user to provide commands or other information in connection with the control of bathing unit system 10 (shown in FIG. 1) as well as to request status information in connection with the bathing unit system 10. Amongst others, the remote control client 250 implements a user interface that can be displayed on a display screen of the personal computing device 1200. In a specific implementation, the personal computing device 1200 includes a user input device (which can also be referred to as user operable controls) and a display screen. The display screen is operative for displaying a graphical user interface (GUI) to a user that provides the user with information regarding the bathing system 10 (shown in FIG. 1) and enables the user to input commands for controlling various bathing unit components of the bathing system. Amongst others, the user can input commands affecting the spa water temperature, the operation of the jets, the operation of the lights and any other spa components in bathing unit system 10 (shown in FIG. 1). In accordance with a non-limiting example, the GUI comprises a plurality of display screens that can be navigated by a user of the GUI via the user input device in order to access desired information and provide desired inputs for adjusting and activating the operational settings of the bathing unit components. In a specific implementation, the remote control client 250 implements functionality for exchanging messages with the network-enabled controller 24 (shown in FIGS. 1 and 2). As part of this functionality, the GUI is configured for visually conveying operational settings information associated with the bathing system associated with the network-enabled spa controller 24 at least in part based on the messages exchanged with the network-enabled controller 24, the operational settings information associated with the bathing system including water temperature settings associated with the bathing system.

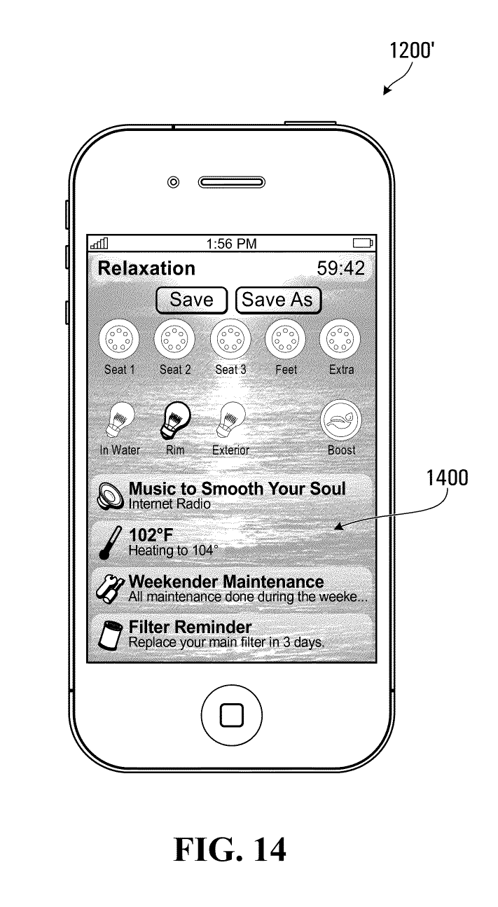

FIG. 14 of the drawings shows a non limiting implementation of a personal computing device 1200′ in the form of a smart phone having a display screen 1400. The personal computing device 1200′ executes program instructions implementing a remote control client including a graphical user interface (GUI) which is displayed on the display screen 1400. In this non-limiting example, the program instructions implementing the remote control client are part of a software application that can be downloaded to the personal computing device 1200′ from an Internet accessible server according to known methods.

The particular spa control and monitoring functionality provided by the remote control client 250 may vary from one implementation to the other and is not critical to the present application and as such will not be described in greater detail here. For greater information on the type of spa control and monitoring functionality that can be provided through spa client remote control client 250 executed by the personal computing device 1200, the reader is invited to refer to the following co-pending U.S. patent applications:
U.S. patent application Ser. No. 12/916,160, filed on Oct. 29, 2010, entitled “A METHOD AND SYSTEM FOR CONTROLLING A BATHING SYSTEM IN ACCORDANCE WITH AN ENERGY SAVINGS MODE”, by Benoit Laflamme et al.; and
U.S. patent application Ser. No. 12/910,615, filed on Oct. 22, 2010, entitled “A METHOD AND SYSTEM FOR PROVIDING AMBIANCE SETTINGS IN A BATHING SYSTEM”, by Benoit Laflamme et al.; and

The contents of the aforementioned documents are incorporated herein by reference.

The remote control client 250 implemented by the personal computing device 1200 also implements remote connectivity functionality for establishing a communication link with the network-enabled controller 24 through the router 220.

In the example depicted in FIG. 2, personal computing device 1200 has been shown as being part of a public (Internet) network. It is noted that in cases where the remote control client is on a public (Internet) network, no NAT traversal protocol is required since the public address is already known. Although personal computing device 1200 has been shown in FIG. 2 as being part of a public (Internet) network, in alternative embodiments the personal computing device 1200 may be located in a private network distinct from private network 210 and may be connected to the public Internet via a router implementing a network address translator (NAT) protocol.

In implementations in which the communication relationship to be established between the remote control client 250 and the network-enabled spa controller 24 through the server 230 is a client-server relationship in which the remote control client 250 behaves as the “client” and issues requests to the network-enabled spa controller 24 and in which the network-enabled spa controller 24 behaves as the “server” and replies to these requests, no NAT traversal protocol on the side of the remote control client 250 is required since each exchange between the remote control client 250 and the network-enabled spa controller 24 is initiated by the remote control client 250. In alternate implementations in which it is desirable for the remote control client 230 and the network-enabled spa controller 24 to establish a peer-to-peer communication relationship, in which either one of the network-enabled spa controller 24 and the remote control client 230 can initiate a communication, a NAT traversal protocol such as STUN may also be applied by the server to the remote control client 230 in order to determine the public network address of the remote control client.

For the purpose of simplicity, the present description will consider a situation in which a NAT traversal protocol on the side of the remote control client 250 is not required. In light of the present description, it will become readily apparent to the person skilled in the art how a NAT traversal protocol could be applied in connection with the remote control client 230 and as such no further details will be provided here.

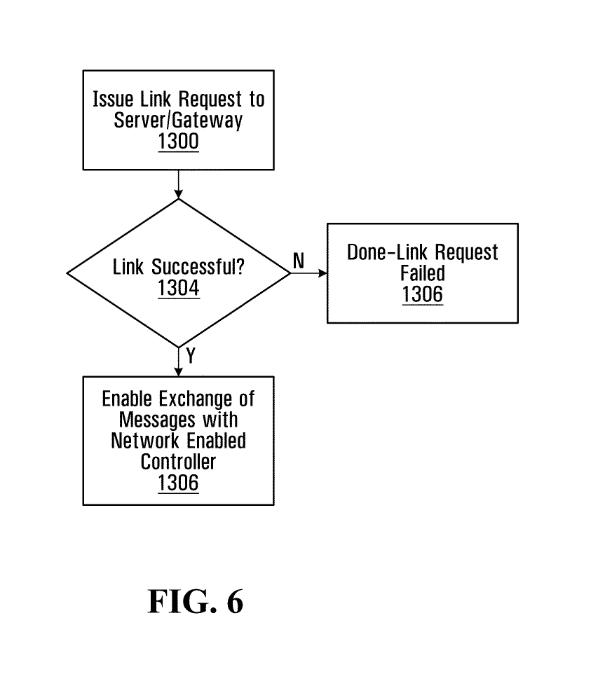

FIG. 6 of the drawings shows a process implemented by the remote control client 230 executed by the processor 1208 of the personal computing device 1200 (shown in FIG. 5) for establishing a communication link with the network-enabled controller 24 through server 230. The communication link request is established in accordance with methods known in the art and may include security related functionality, such as providing a pass code associated with the network-enabled controller 24.

As shown, at step 1300, the remote control client 230 issues a link request message to the server 230 requesting to enter into communication the network-enabled controller 24. The address of the server 230, preferably in the form of a Uniform Resource Locator (URL) is specified by information stored in the memory unit 1210 (shown in FIG. 5) of the personal computing device 1200. In a first example the link request includes information identifying the network-enabled controller 24. The information identifying the network-enabled controller 24 may include for example, the media access control (MAC) address of the network-enabled controller 24, a serial number, a user assigned character string (e.g. Bob's_spa), a manufacturer assigned character string or any other suitable manner for identifying the network-enabled controller 24. In a second example, the link request includes information identifying the personal computing device 1200. The information identifying the personal computing device 1200 may include for example, the media access control (MAC) address of the personal computing device 1200, a serial number, a user assigned character string (e.g. Bob's_phone), a manufacturer assigned character string or any other suitable manner for identifying the personal computing device 1200. In a third example, the link request includes information identifying the network-enabled controller 24 and the personal computing device 1200.

It is noted that the link request message will include a public network address, including a public IP address component and an external port. The server 230 processes the link request message. In some implementations, a portion of the processing of the link request message may also be performed by the network-enabled controller. Examples of the manner in which the server 230 can process the link request will be described later on the present specification.

If the link request fails, the server 230 will either transmit a “failure to link” message to the device 1200 or alternatively will transmit nothing. If either a “failure to link” message is received by the personal computing device 1200 or if no response is received after a certain time following the transmission of the link request to the STUN 230, step 1304 will be answered in the negative and the link request attempt will be considered to have failed. The personal computing device 1200 may make multiple link request attempts until a link request succeeds or until a maximum number of attempts that have failed has been reached. If at step 1304 it is determined that a maximum number of attempts that have failed has been reached, the process will proceed to step 1306 where the process terminates due to a failure in establishing a link with the network-enabled controller 24 through the server 230. Optionally at step 1306, information indicating the reason for the termination, namely that the personal computing device 1200 failed to successfully establish a link with the network-enabled controller 24 through the server 230, is stored in a memory (for example memory 1210 shown in FIG. 5). Information indicating the reason for the termination can also be conveyed to the user of the personal computing device 1200 through display means (not shown in the Figures).

If the link request succeeds, the server 230 will transmit a “link success” message to the personal computing device 1200. In a specific implementation, the link success response will include the public network address associated with the network-enabled controller 24 as observed from the perspective of the server 230. Alternatively, the link success message may simply provide an information identifying the network-enabled controller 24 to which the personal computing device 1200 has now been linked. As part of the link process, the server may also store information mapping the public network address of the personal computing device 1200 (and/or information identifying the device) to the public network address of the network-enabled controller 24 (and/or information identifying the network-enabled controller 24). If a “link response” is received by the personal computing device 1200, step 1304 will be answered in the affirmative and the link attempt will be considered to have succeeded. In such case, the process will proceed to step 1306.

At step 1306, which is initiated in response to a successful link acknowledgement message received through the server 230, the personal computing device 1200 enters into a communication relationship with the network-enabled controller 24 in a usual manner. Messages can then be exchanged between the personal computing device 1200 and the network-enabled controller 24 through server 230 in accordance with the communication relationship. Alternatively the messages exchanged may by-pass server 230 and be exchanged between personal computing device 1200 and the network-enabled controller 24 over the public Internet.

In specific examples of implementation, the communication relationship entered by the personal computing device 1200 with the network-enabled controller 24 may be either a peer-to-peer communication relationship (in which either one of the network-enabled spa controller 24 or the remote control client 230 can initiate a communication) or a client-to-server communication relationship. In situations where the communication relationship is a client-to-server communication relationship, the personal computing device 1200 running the remote control client 250 behaves as the “client” and issues requests to the network-enabled spa controller 24 and the network-enabled spa controller 24 behaves as the “server” and replies to these requests.

The process depicted in FIG. 6 may be executed by the personal computing device 1200 (shown in FIG. 5) on the basis of program instructions 1214 stored in the memory 1210. A process of the type depicted in FIG. 6 may be initiated on power-up of the personal computing device 1200 or on instantiation of the remote control client 250 implemented by program instructions 1214. The process depicted in FIG. 6 may also be initiated on the basis of a command provided by the user, either through a user operable input device (not shown in the Figures) through I/O interface 1216.

As a result of the processes illustrated in FIGS. 4 and 6, a communication relationship has been established between the network-enabled controller 24 and the personal computing device 1200 through the server 230. The person skilled in the art will appreciate that, in the case of a peer-to-peer communication relationship if the respective NATs associated with the network-enabled controller 24 and the personal computing device 1200 permit traversal (“hole punch”), once the communication relationship has been established through the server 230, messages may be exchanged between the network-enabled controller 24 and the personal computing device 1200 without going through the server 230. In the case whether the NATs do not permit traversal (“hole punch”), the messages may be exchanged between the network-enabled controller 24 and the personal computing device 1200 through the server 230.

In specific examples of implementation, the network process unit 40 (shown in FIG. 1) of the network-enabled controller 24 is programmed for processing various messages originating from the remote control client 250. Such messages may include for example status request messages for obtaining information related to operational parameters/settings of the bathing unit and commands for modifying one or more operational parameters of the spa. Optionally, the network-enabled controller 24 may perform an authentication of the remote control client at least in part by processing the messages received from the remote control client 250 at the network-enabled controller 24. In such cases, the network-enabled controller 24 may be programmed for selectively taking an action corresponding to the message received in dependence on results obtained by performing the authentication of the remote control client from which the received message originated. Such authentication allows limiting monitoring and/or control capabilities to certain specific remote control clients and/or users and prevents other remote control client and/or users from controlling and/or obtaining information associated with the network-enabled controller 24. In an alternate implementation, authentication functionality may be omitted from the network-enabled controller 24 and be performed at the server 230. In such alternate implementations, the server 230 selectively forwards messages to the network-enabled controller 24 in dependence on results obtained by performing the authentication of the remote control client from which the message originates.

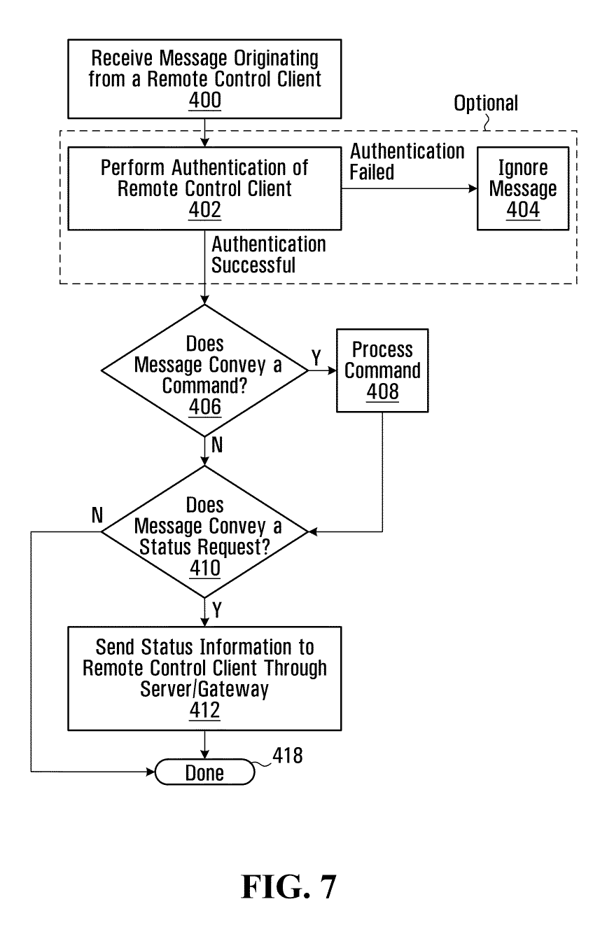

An example of a message exchange between the network-enabled controller 24 and the personal computing device 1200 through the server 230 will now be described from the perspective of the network-enabled controller 24 with reference to FIG. 7. The process shown in FIG. 7 considers that the message transmitted by the personal computing device 1200 conveys a command and/or a status request.

At step 400, a message originating from a remote control client is received by the network-enabled controller 24 through the server 230 (shown in FIG. 2).

At step 402, the received message is processed to authenticate the remote control client from which the message originated. Authentication of the remote control client may be done using any suitable method and such methods which may be used alternately to one another or in combination depending on the type and level of authentication that is to be achieved. Authentication of the remote control client may be based on a password, a machine identifier, an IP address or any other suitable mechanism.

In a first specific implementation, authentication of the remote control client may be performed on the basis of a password to be provided by a user of the personal computing device 1200 and included as part of the message received. In such implementation, the contents of the received message are compared to a password stored in a memory of network-enabled controller 24 (for example memory unit 42 shown in FIG. 1). If the comparison concludes that there is a match, the authentication is considered successful otherwise it is considered to have failed.

In another specific implementation, authentication of the remote control client may be performed on the basis of an identifier associated with the personal computing device on which the remote control client is operating. In such an implementation, the identifier associated with the personal computing device is sent as part of each packet transmitted by the remote control client. In a non-limiting example, the identifier used to authenticate the remote control client is the media access control (MAC) address associated with the remote computing device operating the remote control client. In such situations, the network-enabled controller 40 may store in a memory (for example memory unit 42 shown in FIG. 1) one or more MAC addresses associated with devices that are authorized to monitor and/or control the network-enabled controller. The MAC addresses of the authorized devices may have been provided to the network-enabled controller during a registration procedure between the devices and the network-enabled controller 24. Since MAC addresses are unique amongst network ready devices, the use of MAC addresses for authentication purposes allows only devices that have been registered with the network-enabled controller 24 to interact with the network-enabled controller 24. When a message is received at the network-enabled controller 24, authentication is performed by comparing the MAC address of the device that sent the message against the MAC addresses stored in the memory of the network-enabled controller 24. If the comparison concludes that there is a match, the authentication is considered successful otherwise it is considered to have failed. Although the above example has been described using the MAC address of the device that sent the message, it is to be appreciated that any other suitable identifier associated with the device that sent the message may be used to authenticate the remote control client.

In another implementation, authentication of the remote control client may be performed on the basis of an encryption key used to encrypt the messages exchanged between the network-enabled controller 24 and the personal computing device 1200. If the use of the encryption key on the receiving end of the communication, in this case at network-enabled controller 24, to decrypt a received message does not result in the message being readable, the authentication is considered to have failed and the received message is discarded. Conversely, if the use of the encryption key to decrypt a received message results in the message being readable, the authentication is considered to have succeeded. Any suitable encryption key may be used. As non-limiting examples, the encryption key may be the MAC address of the network-enabled controller 24, or the MAC address of the personal computing device 1200, or a combination of the two MAC addresses or an encryption key associated with the private (home) network 210 (shown in FIG. 2).

It is to be appreciated that suitable methods for authenticating the remote control client other than the ones described above may be used in alternate embodiments.

If at step 402, the authentication was found to be unsuccessful, the process proceeds to step 404 and the message received at step 400 is ignored by the network-enabled controller 24. Optionally an error message may be transmitted back to the remote client indicating that the message was ignored along with the reason (for example “incorrect password”).

If at step 402, the authentication was found to be successful, the process proceeds to step 406.

Optionally still, in cases where the authentication was found to be successful, information conveying the permitted actions associated with the successful authentication are also generated. For example, a specific remote control client authenticated by means of a first password and/or a device identifier may be associated with a first permission type while another specific remote control client authenticated by means of a second password and/or a device identifier may be associated with a second permission type. The table below illustrates a non-exhaustive list of examples of permission types that may be associated with the authenticated remote control client.

| PERMISSION | |
|---|---|
| TYPE | DESCRIPTION |
| Level 1 | Monitoring privileges only (e.g. only execute message |
| | conveying commands requesting setting/status |
| | information. All other commands ignored.) |
| Level 2 | Monitoring privileges |
| | Basic Control privileges (e.g. only execute message |
| | conveying commands requesting certain types of setting |
| | modifications (e.g. water temperature modification and |
| | pump settings). All other commands ignored) |
| Level 3 | Monitoring privileges |
| | Full Control privileges |

In alternate embodiments, authentication of the remote control device may be performed by the server 230 rather than by the network-enabled controller 24. In such cases, steps 402 and 404 pertaining to the authentication of the remote control client from which the received message originated would be omitted.

At step 406, processing of the contents of the message is performed at the network-enabled controller 24.

If the contents of the message does not convey a command to modify a setting in the bathing system 10 (shown in FIG. 1), step 406 is answered in the negative and the process proceeds to step 410.

If the contents of the message convey a command to modify a setting in the bathing system 10 (shown in FIG. 1), step 406 is answered in the positive and the process proceeds to step 408. In cases where information conveying the permitted actions associated with the successful authentication was provided by step 402, this may also be taken into account in the decision at step 406. For example if the message conveys a command to modify a setting in the bathing system 10 but the permission level associated with the remote control device do not allow this modification, then step 406 would be answered in the negative and would proceed to step 410.

At step 408 the command is processed in a usual manner to cause the spa controller 34 (shown in FIG. 1) to modify the settings. The process then proceeds to step 410.

At step 410, a determination is made as to whether the contents of the message convey a status request. If the contents of the message do not convey a status request, the system proceeds to step 418. If the contents of the message do convey a status request, the system proceeds to step 412.

At step 412, the network-enabled controller 24 generates a reply message conveying the operational settings information associated with the bathing system based on information stored in memory 42 (shown in FIG. 1). Some non-limiting examples of operational settings include water temperature control settings, jet control settings, and lighting settings, among other possibilities. The reply message conveying the operational settings information is sent to the personal computing device 1200 through the server 230. The reply message may include information identifying the network-enabled controller 24, including for example the media access control (MAC) address of the network-enabled controller 24, a serial number, a user assigned character string (e.g. Bob's_spa), a manufacturer assigned character string or any other suitable manner for identifying the network-enabled controller 24.

At step 418, the processing of the message received at step 400 is completed.

### Server 230

In practical implementations of the remote control and monitoring system depicted in FIG. 2, the server 230 will be configured for interconnecting a plurality of network enabled controllers, such as network enabled controller 24, with a plurality of personal computing devices executing remote control clients, such as personal computing device 1200 and remote control client 250.

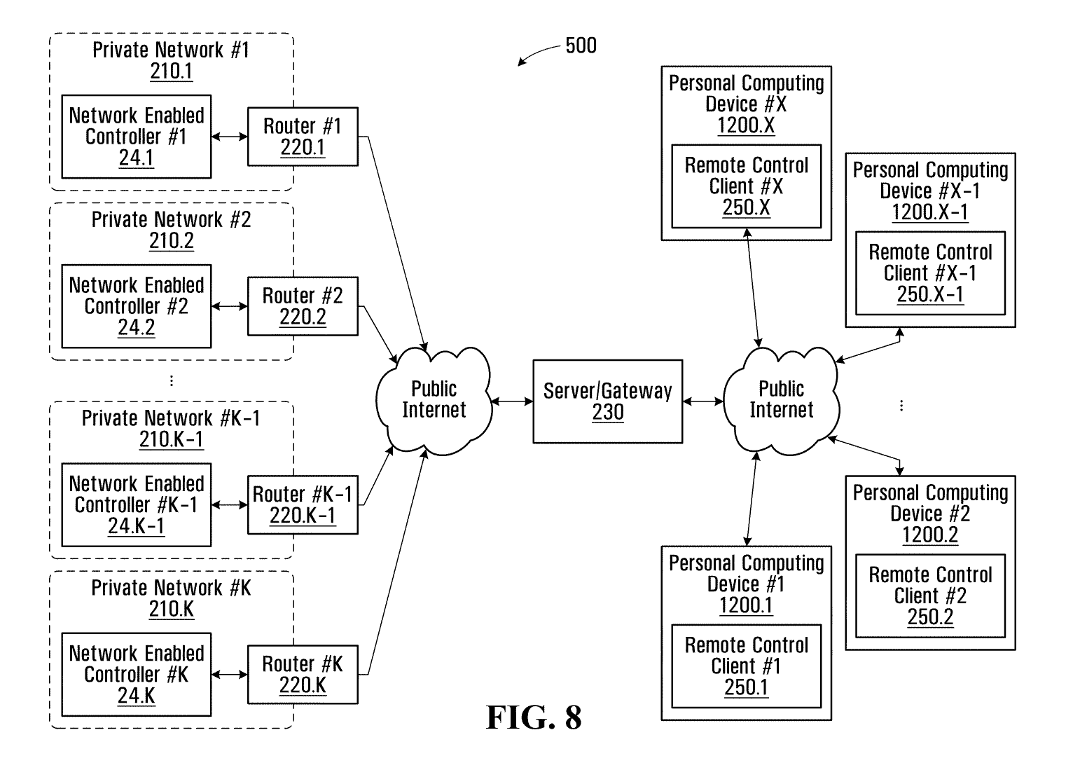

FIG. 8 of the drawings is a block diagram of a system 500 including the server 230 for enabling control and monitoring of network-enabled controllers for bathing units by remote control clients. As shown, the system 500 includes a plurality of network enabled spa controllers 24.1 to 24.k (#1 to #K) and a plurality of personal computing devices 1200.1 to 1200.X running remote control clients 250.1 to 250.X (#1 to #X) which can communicate with one another over the public Internet using communication links established through server 230.

Each one of network enabled spa controllers 24.1 to 24.k (#1 to #K) is analogous to network enabled spa controllers 24, described above with reference to FIG. 2, and is part of a respective private network established by a corresponding router. Each one of private network 210.1 to 210.k (#1 to #K) is analogous to private (home) network 210 described previously with reference to FIG. 2 and each one of router 220.1 to 220.k (#1 to #K) is analogous to router (NAT) 220 also described previously with reference to FIG. 2. Similarly each one of personal computing devices 1200.1 to 1200.X running remote control clients 250.1 to 250.X (#1 to #X) is analogous to personal computing device 1200 running remote control client described previously with reference to FIG. 2. It is noted that a specific remote control client (say remote control client 250.1) may exchange messages with one or more network-enabled controllers, for example network-enabled controllers 24.1 and 24.2. Similarly, specific network-enabled controller, say network-enabled controller 24.1, may exchange messages with one or more remote control clients, say for example remote control client 250.1 and remote control client 250.2.

In a specific example of implementation, the server 230 maintains active communications links with the network enabled spa controllers 24.1 to 24.k (#1 to #K). In a first implementation, active communication links may also be maintained between the server 230 and each of personal computing devices 1200.1 to 1200.X. Alternatively, the communication links between the server 230 and the personal computing devices 1200.1 to 1200.X may be established when the personal computing device wishes to send a message to a designated one of the network enabled spa controllers 24.1 to 24.k (#1 to #K) and destroyed once a reply is received and/or the communication link remains unused for a period of time exceeding a certain delay.

As mentioned with reference to FIG. 3 showing a functional block diagram of the server 230, the server 230 includes a processor 600 and memory unit 602 connected by a communication bus. In a system of the type depicted in FIG. 8, the memory unit 602 may store an address-translation table allowing mapping information associated with different registered network enabled spa controllers in the system 500 to information associated with respective personal computing devices.

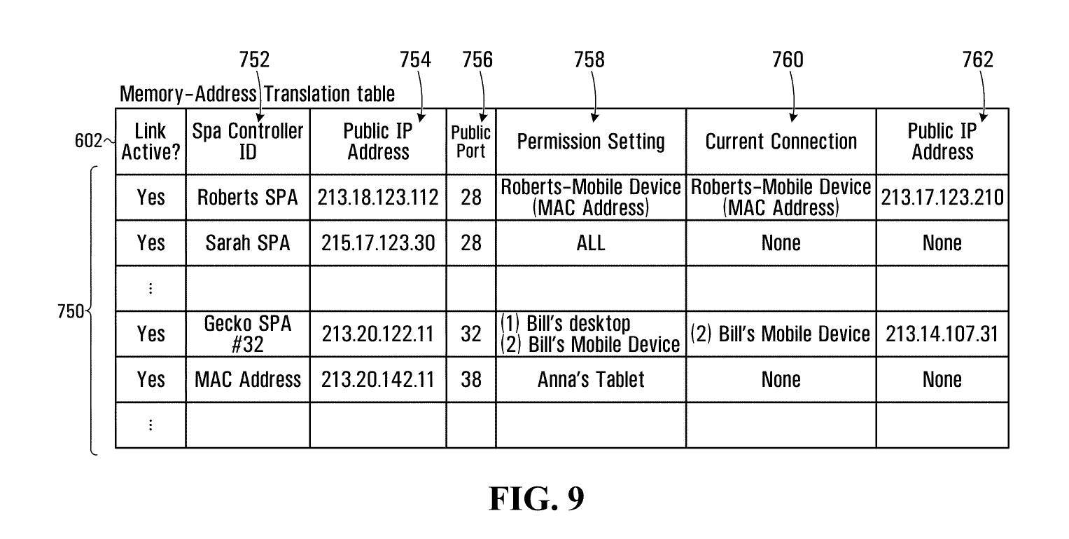

FIG. 9 shows a conceptual illustration of an address-translation table that may be stored in memory 602 of server 230. In the example illustrated, the table includes a plurality of entries 750 each of which is associated with a respective registered network-enabled controller with which a communication link is being maintained. Each registered network-enabled controller may be associated with identification information (e.g. a MAC address) 752, a public IP address 754, a public port 756 and information associated with one or more personal computing devices. The information associated with one or more personal computing devices may include permissions settings associated with certain personal computing devices 758, the personal computing device(s) currently linked with a specific network-enabled controller 760 as well as the public IP address 762 and public port (not shown in the Figures) of the personal computing device linked with the network-enabled controller.

The server 230 in the system of FIG. 8 implements various processes in connection with enabling control and monitoring of network-enabled controllers for bathing units by remote control clients.

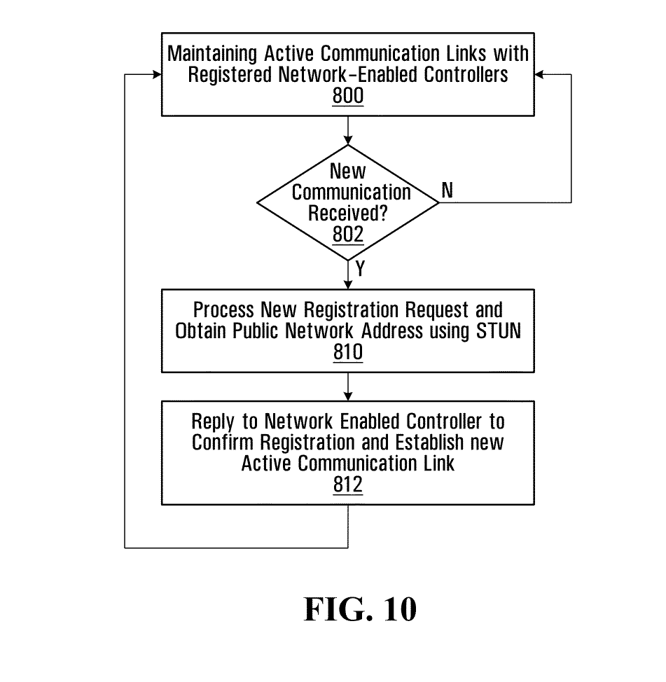

A few of these processes will now be described with reference to FIGS. 10, 11, 12 and 13 of the drawings.

Shown in FIG. 10 is a process implemented by the server 230 in connection with maintaining active communications links with registered network enabled controllers as well registering new networks enabled controllers.

As shown, at step 800, the server 230 maintains active communication links with a plurality of registered network-enabled controllers for bathing units. For the purpose of clarity, a registered network-enabled controller will refer to a network-enabled controller for which an active communication link is being maintained by the server. At least some of the network-enabled controllers in the plurality of registered network-enabled controllers communicate with the server through respective home routers are associated with respective public network addresses. In a specific example of implementation, the communication links with the plurality of registered network-enabled controllers are maintained as active by the transmittal of “Keepalive” type messages by the registered network-enabled controllers. Although step 800 is shown as a distinct step in the process depicted in FIG. 10, it is to be understood that the maintenance of the active communication links with the registered network-enabled controllers for bathing units occurs continuously and concurrently with other processes.

While no new registration requests are received, step 802 is answered in the negative and the server 230 continues to maintain the active communication links with currently registered network-enabled controllers.

If a registration requests originating from a new network enabled controller is received, step 802 is answered in the positive and the process proceeds to step 810.

At step 810, the registration request is processed by the server 230. More specifically, the registration request is processed to obtain a public network address associated with the new network-enabled controller from which the registration request originated. The public network address may include a public IP address component and a public port identifier. In a specific example of implementation, the registration of a new network enabled controller is performed in accordance with a STUN protocol. The registration request may also convey identification information associated with the network enabled controller from which the request originated. In a specific example of implementation, the registration process may include creating a new entry in an address translation table (for example of the type shown in FIG. 9) stored in a memory of the server 230. In an alternative example of implementation, the registration process may include marking an existing entry in an address translation table stored in a memory of the server 230 as having a link that is “active”. The process then proceeds to step 812.

At step 812, the server 230 sends a reply to the network enabled controller from which the registration request originated. The reply message can include, amongst other, the public network address obtained. Following this, the process proceeds to step 800 where the server 230 continues to maintain active communication links with a plurality of registered network-enabled controllers for bathing units, now including a newly added communication link with the new-enabled controller.

Although the process described with reference to FIG. 10 shows a process including registering a new network enabled controller, a similar process can be applied in situations in which a network enabled controller for which an active communication link is being maintained issues a signal requesting to be removed from the plurality of communication links being maintained.

The server 230 network in system 500 (shown in FIG. 8) is also programmed for directing different communications between the remote control clients 250.1 to 250.X to specific network enabled controllers 24.1 to 24.k over the communication links being maintained. Such communications may include for example status request messages for obtaining information related to operational parameters/settings of the bathing unit and commands for modifying one or more operational parameters of the spa as well as replies to these messages. Optionally, the server 230 may perform an authentication of the remote control client at least in part by processing the communications received from remote control clients at the server 230. In such cases, the server 230 may be programmed for selectively directing a communication to a specific network-enabled controller in dependence on results obtained by performing the authentication of the remote control client from which the communication originated. Such authentication allows limiting monitoring and/or control capabilities to certain specific remote control clients in connection with specific network-enabled controllers. In an alternate implementation, authentication functionality may be omitted from the server 230 and be performed at the network-enabled controllers.

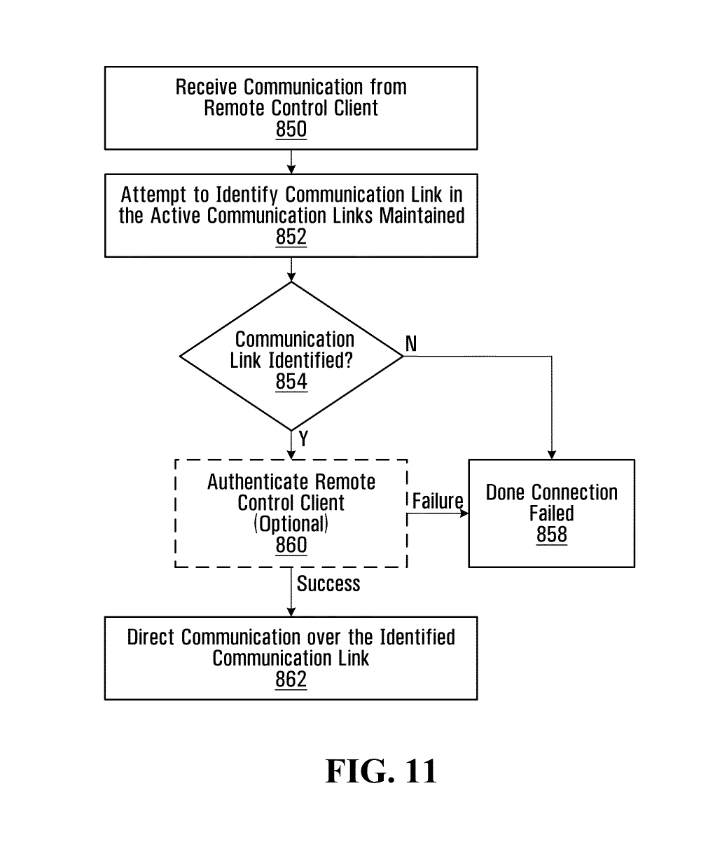

Shown in FIG. 11 is a process implemented by the server 230 in connection with a communication directed to network enabled controller received from a remote control client.

At step 850, a communication originating from a remote control client and directed to a specific registered network-enabled controller in system 500 (shown in FIG. 8) is received at the server 230. In a non-limiting example, the communication includes one or more IP packets. The communication includes information identifying the remote control client from which the request originated and information identifying the specific registered network-enabled controller in system 500 to which the communication is directed. The specific registered network-enabled controller and the remote control client from whom the communication originated may be identified in a number of different manners. Some non-limiting examples of implementation of manners in which a remote control device may be identified in a communication include a name associated with the remote control device, the media access control address (MAC) address associated with the remote control device, the public network address of the remote control device or any other suitable identifier for identifying a specific network-enabled controller amongst other network-enabled controllers. Some non-limiting examples of implementation of manners in which a specific registered network-enabled controller may be identified in a communication include a name associated with the network-enabled controller, the media access control (MAC) address associated with the network-enabled controller or any other suitable identifier for identifying a specific network-enabled controller amongst other network-enabled controllers. In a variant, the public network address of the specific registered network-enabled controller, which in such a variant would have been provided to the remote control client in response to a link request issued by the remote control client (see FIG. 6)), is conveyed by the communication received from the remote control client to identify the specific registered network-enabled controller to which the communication is directed.

At step 852, the server 230 processes the communication to identify a communication link amongst the communication links being maintained with registered network-enabled controllers in system 500. In a specific implementation, the server is programmed to access an address-translation table of the types described with reference to FIG. 9 in order to identify a communication link amongst the active communication links maintained with the plurality of registered network-enabled controllers based on information conveyed by the communication. The identification of the communication may be done on the basis of the information conveying by the communication identifying the remote control client from which the communication originated and/or identifying the specific registered network-enabled controller to which the communication is directed.

If no active communication link is identified by step 852, step 854 is answered in the negative and the process proceeds to step 858 where the process terminates due to a failure in identifying an active communication link maintained at the server 230 and associated with to the specific network enabled controller to which the communication is directed. Optionally at step 858, information indicating the reason for the termination is transmitted to the remote control client from whom the communication originates so that it may be conveyed to a user of the personal computing device on which the remote control device operates.

If an active communication link is identified by step 852, step 854 is answered in the positive and the process proceeds to step 860.

At step 860, the communication is processed to authenticate the remote control client from which the message originated. Authentication of the remote control client may be done using any suitable method and such methods which may be used alternately to one another or in combination depending on the type and level of authentication that is to be achieved. Authentication of the remote control client may be based on a password, a machine identifier, a network address or any other suitable mechanism. Non-limiting examples of approaches for authenticating a remote control client at a network-enabled controller were described with reference to step 402 shown in FIG. 7. Similar approaches to those described at step 402 may also be applied by the server in connection with step 860.

If at step 860, the authentication was found to be unsuccessful, the process proceeds to step 858 where the process terminates due to a failure to authenticate the remote control client. In this manner the communication originating from the specific remote control client received by the server 230 at step 850 is prevented from reaching the specific registered network-enabled controller in dependence of the results of the authentication performed at step 860. Optionally at step 858, information indicating the reason for the termination is transmitted to the remote control client from whom the communication originates so that it may be conveyed to a user of the personal computing device on which the remote control device operates.

If at step 860, the authentication was found to be successful, the process proceeds to step 862.

In alternate embodiments authentication of the remote control device may be performed by the specific network-enabled controller rather than by the server 230. In such cases, step 860 pertaining to the authentication of the remote control client from which the received message originated would be omitted.

At step 862, the server 230 directs the communication received at step 850 from the specific remote control client to the specific registered network-enabled controller over the communication link identified at step 852 according to usual manners. In a non-limiting implementation, the communication received at step 850 is modified so that it conveys as its destination the public network address of the specific network-enabled controller to which the communication is directed.

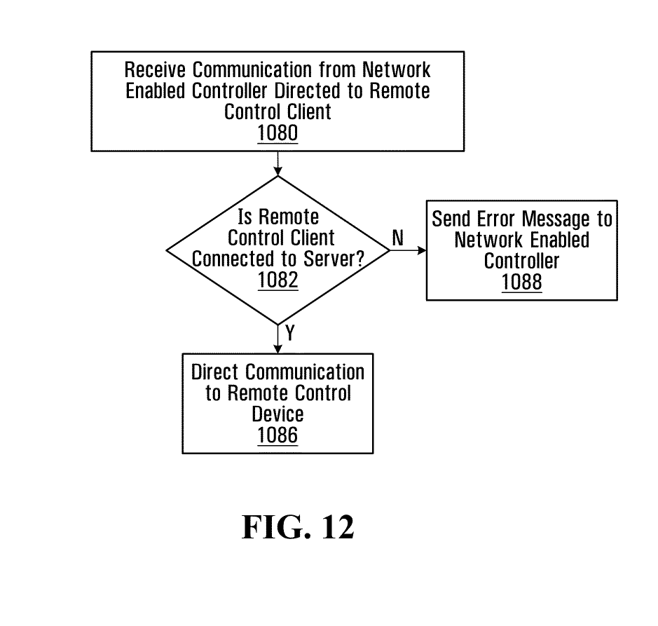

Shown in FIG. 12 is a process implemented by the server 230 in connection with a communication received from a network enabled controller and directed to a specific remote control client.

At step 1080, a communication originating from a specific registered network-enabled controller and directed to remote control client in system 500 (shown in FIG. 8) is received at the server 230. In a non-limiting example, the communication includes one or more IP packets. The communication includes information identifying the remote control client to which the communication is directed and information identifying the specific registered network-enabled controller in system 500 from which the communication originated. The specific registered network-enabled controller and the remote control client from whom the communication originated may be identified in a number of different manners, some examples of which have been set forth previously in the present description.

At step 1082, the server 230 processes the communication to determine whether the specific remote control client is currently connected to the server. In a specific implementation, the server is programmed to access an address-translation table of the types described with reference to FIG. 9 in order to identify a communication link based on information conveyed by the communication. The identification of the communication may be done on the basis of the information identifying the remote control client to which the communication is directed and/or identifying the specific registered network-enabled controller from which the communication originated.

If at step 1082 no connection or link is found at the server 230 with the specific remote control client, step 1082 is answered in the negative and the process proceeds to step 1088 where the process terminates due to a failure in identifying a connection at the server 230 associated with to the specific remote control client to which the communication is directed. Optionally at step 1088, information indicating the reason for the termination is transmitted to the network-enabled remote controller from which the communication originated.

If a connection or link is found at the server 230 with the specific remote control client, step 1082 is answered in the positive and the process proceeds to step 1086.

At step 1086, the server 230 directs the communication received at step 1080 from the specific registered network-enabled controller to the specific remote control client over the connection or link identified at step 1082 according to usual manners. In a non-limiting implementation, the communication received at step 1080 is modified so that it conveys as its destination the public network address of the specific network remote control client to which the communication is directed.

In specific examples of implementations, the server 230 network in system 500 (shown in FIG. 8) may further be programmed for detecting failures in connection with the active communication links being maintained with the registered network-enabled controllers. In a specific example of implementation, the processor is programmed for detecting of a failure in an active communication link maintained with a registered network-enabled controller at least in part by detecting an absence of receipt of signals originating from the corresponding registered network-enabled controller within a time delay. In this manner, for example, if there is a power failure causing network enabled controller 24.1 (shown in FIG. 8) to cease to receive power, the server 230 will detect a failure in the active communication link maintained with network enabled controller 24.1 prior to the failure since network enabled controller 24.1 will no longer be able to maintain that link active, for example by sending a periodic communication to the server 230. In response to detection of a failure of one of the active communication links being maintained with the registered network-enabled controllers, the server 230 can be programmed for initiating a failure advisory process in connection with a registered network-enabled controller corresponding to the active communication link for which the failure was detected. The actions taken in connection with a failure advisory process may vary from one implementation to the other.

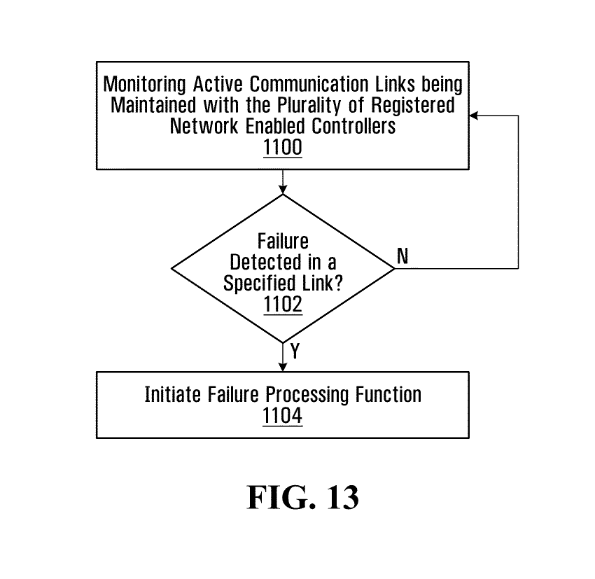

Shown in FIG. 13 is a process implemented by the server 230 in connection with monitoring and detecting failure in communication links being maintained with a plurality of registered network enabled controllers in system 500 (shown in FIG. 8).

At step 1100, the server 230 monitors the status of the communications links being maintained with the plurality of registered network enabled controllers. The monitoring includes verifying whether these links remain active. In a specific example of implementation, the communication links are maintained as active by the transmittal of multiple signals to the server 230 over time (for example “Keepalive” type messages), the signals being transmitted over time at time intervals by the respective registered network-enabled controllers. In such situations, the server 230 is programmed to monitor the communication link to detect whether signals are received from corresponding network-enabled controllers within a specified time interval. While signals are received within a specified maximum time delay for the communication links, the server 230 considers that the communication links remain active. A failure is detected in association with a specific active communication link if no signal is received from a corresponding network-enabled controller within the specified maximum time delay. The specified maximum time delay may vary from one implementation to the other. In a specific non-limiting example of implementation, the specified maximum time delay is about one minute. In another specific non-limiting example of implementation, the specified maximum time delay is between about thirty minutes and about one hour. In yet another specific non-limiting example of implementation, the specified maximum time delay is a few hours.

If no failure is detected, step 1102 is answered in the negative and the monitoring process continues at step 1100.

If a failure is detected in association with a specific active communication link, the process proceeds to step 1104.

At step 1104, in response to detection of a failure of the specific active communication link, the server 230 may initiate a failure processing function in connection with a registered network-enabled controller corresponding to the active communication link for which the failure was detected.

The actions taken in connection with the failure processing function may vary from one practical implementation to the next.

In a first non-limiting example of a failure processing function, the server 230 may attempt to reactivate the communication link for which a failure was detected, for example by sending a message to the public network address of the corresponding registered network-enabled controller.

In a second non-limiting example of a failure processing function, which may be used separately or jointly with the first example of a failure processing function, the server 230 may store information in a failure monitoring database in connection with the registered network-enabled controller corresponding to the active communication link for which the failure was detected. This information can be used by a spa service technician in order to identify bathing unit systems that require maintenance and/or repair.

In a third non-limiting example of a failure processing function, which may be used separately or jointly with the first and/or second examples of a failure processing function, the server 230 may initiate a failure advisory process in connection with the registered network-enabled controller corresponding to the active communication link for which the failure was detected. The failure advisory process is for communication the detection of the failure in the active communication link to an individual, for example the owner of the corresponding bathing unit or service technician, so that suitable actions may be taken in connection with the detected failure. The failure advisory process may include, for example, transmitting a message to a bathing unit service technician identifying the registered network-enabled controller corresponding to the active communication link for which the failure was detected. Alternatively, the failure advisory process may include transmitting a message to the owner of the network-enabled controller corresponding to the active communication link for which the failure was detected. The message(s) sent to the service technician and/or owner may be transmitted using any suitable communication manner including but not limited to a phone call (which may be automated), an e-mail message, a facsimile, an SMS (Short Message Service) message or any suitable manner of sending a message to an individual. In such implementations, the server 230 is programmed to store contact information associated with one or more individuals to be contacted when a failure is detected. In a specific implementation, the contact information may be stored in an address translation table, of the type shown in FIG. 9, in association with a corresponding active communication link.

In a non-limiting example, the server 230 is operated by a spa servicing entity which provides spa monitoring services to subscribers. For example, a contract may be established between the spa owner and the servicing company which would contemplate the payment of a monthly fee to the servicing company in exchange for monitoring the owner's spa. As part of the contract, the servicing company would allow an active communication link to be maintained between the network enabled controller of the owner's spa and server 230. The spa servicing company would also monitor the active communication link established to detect a failure in the link. In response to detection of a failure in the link, the server 230 would issue a message to the servicing company, which would react in accordance with an established procedure to address the failure.

It is to be appreciated that certain alternative implementations of the server may omit the failure detection functionality described with reference to FIG. 13.

### Alternative Example of Implementation

With reference to FIG. 1, the network-enabled controller 24 was described as including a spa functionality controller 34 for controlling the set of bathing unit components 11, 13, 26, 28, 30 and a network processing unit 40 for coordinating interactions between the spa controller and external devices. The spa functionality controller 34 and the network processing unit 40 were shown as being part of a same device.

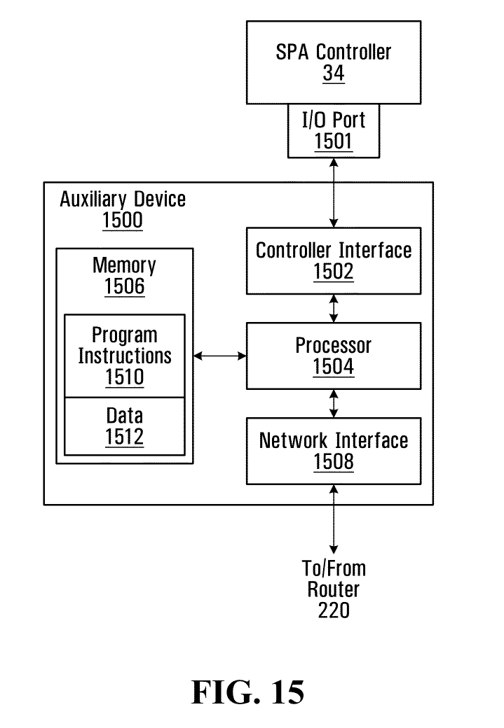

In a variant, shown in FIG. 15, functionality for coordinating interactions between the spa controller and external devices can be provided by an auxiliary device 1500 that is separate from a device including the spa functionality controller 34 and that can be connected thereto via an I/O interface port 1501.

In this alternative implementation, the auxiliary device 1500 includes a controller interface 1502, a processing unit 1504, a memory 1506 and a network interface 1508. Network interface 1508 is analogous to network interface 68 (shown in FIG. 1). The controller interface 1502 is for establishing a communication link with the spa functionality controller 34 to exchange data with the spa functionality controller 34 including commands and operational settings information. The memory 1504 stores program instructions 1510 and data 1512 for use by processor 1504. Amongst others, program instructions 1510, when executed by processor 1504, implement the required functionality for communicating with spa functionality controller 34 over controller interface 1502. Amongst other, the processor is programmed to periodically communicate with the spa functionality controller 34 in order to obtain operational settings information and operational status information associated with the bathing unit and for transmitting commands through the controller interface for causing operational settings in the bathing unit to be modified. Amongst other, water temperature settings and water temperature information is obtained from the spa functionality controller 34. The operational settings information and operational status information periodically obtained from the spa functionality controller 34 are stored as part of the data 1512 in memory 1506.

The program instructions 1510, when executed by processor 1504, also implement functionality similar to that described in connection with processor 40 (shown in FIGS. 1 and 2). Amongst others, when executing program instructions 1510, processor 1504 is programmed for connecting to a home network through the network interface 1508 and for registering with an Internet accessible server implementing a gateway, such as server 230 (shown in FIG. 2). Processor 1504 is also programmed for maintaining an active communication link between the auxiliary device and the server 230 and for exchanging messages through server 230 with a personal computing device implementing a remote control client, such as personal computing device 1200 implementing a remote control client 250 (shown in FIG. 2).

Although the present application has indicated that messages exchanged between the personal computing device 1200 and the network-enabled controller 24 include command and status request messages, it is to be appreciated that other type of data may be exchanged between these devices in accordance with the communication relationship established between them. Such data may include audio and/or video streaming signals from the personal computing device 1200 to the network-enabled controller 24. In a first example, the streaming signals may be transmitted from the personal computing device 1200 to the network-enabled controller 24 through server 230 in accordance with the communication relationship. Alternatively, the streaming signals may by-pass server 230 and be transmitted from personal computing device 1200 to the network-enabled controller 24 over the public Internet in situations where the communication to the network-enabled controller 24 is “hole punching” ready.

In addition, although the present application has focused on systems and devices for providing a user wither remote control and monitoring capabilities in connection with a bathing system equipped with a controller, it is to be appreciated that some of the approaches and concepts presented herein may also be applicable to other types of systems equipped with controllers, such as sauna systems and steam-room systems. Thus in these alternative example, respective network-enabled controllers (or auxiliary devices) may be provided each including a network interface and a memory storing operational settings information associated with the respective system in which they are designed to operate. In the case of a sauna system, the operational settings information may include air temperature information, for example. Each of the network-enabled controllers is configured to register with a server implementing a gateway, analogous to server 230 described in the present document, and is configured to maintain an active communication link with the server. Personal computing devices, analogous to personal computing devices 1200, implement remote control clients suitable for the sauna system or the steam-room system (as appropriate) and are configured for establishing a communication link with the network-enabled controllers through the server in accordance with some of the examples described in the present document.

Although various embodiments of the invention have been described and illustrated, it will be apparent to those skilled in the art that numerous modifications and variations can be made without departing from the scope of the invention, which is defined in the appended claims.

1.-50. (canceled)

51. A method for facilitating monitoring of a network-enabled controller for a bathing unit, said method being implemented by a system including at least one processor, said method comprising:
registering the network-enabled controller with the system, the network-enabled controller:
i. communicating with the system through a home router;
ii. being associated with a public network address;
maintaining active a communication link between the system and the registered network-enabled controller, the communication link being maintained active by a periodic transmittal of signals over the communication link to the system by the registered network-enabled controller;
performing a failure detection operation to detect a potential failure in connection with the communication link, wherein detecting the presence of the potential failure includes monitoring the communication link to detect an absence of signals within a time delay;
in response to detection of the potential failure in connection with the communication link, initiating a failure advisory process in connection with the registered network-enabled controller corresponding to the communication link for which the potential failure was detected, wherein said failure advisory process includes issuing a notification conveying the potential failure.

52. A method as defined in claim 51, wherein issuing the notification includes transmitting an electronic message conveying the potential failure over a computing network to a remote computing device.

53. A method as defined in claim 52, wherein the remote computing device is associated with a bathing unit service technician and wherein the electronic message provides an identification of the registered network-enabled controller corresponding to the communication link for which the potential failure was detected.

54. A method as defined in claim 53, wherein the electronic message is one of an e-mail message, a voice-mail message and an SMS message.

55. A method as defined in claim 53, wherein the remote computing device is a phone.

56. A method as defined in claim 52, wherein the remote computing device is associated with an owner of the bathing unit system and wherein the electronic message provides an identification of the registered network-enabled controller corresponding to the communication link for which the potential failure was detected.

57. A method as defined in claim 56, wherein the electronic message is one of an e-mail message, a voice-mail message and an SMS message.

58. A method as defined in claim 52, wherein the failure advisory process includes:
a. accessing a memory medium to obtain contact information associated with the registered network-enabled controller corresponding to the communication link for which the potential failure was detected, the contact information being associated with a person to contact when a potential failure in connection with the communication link is detected;
b. transmitting the electronic message to the remote computing device using the obtained contact information.

59. A non-transient computer readable storage medium for storing computer executable program code for facilitating monitoring of a network-enabled controller for a bathing unit, the network-enabled controller being connected to a home network through a home router, when executed by a system including at least one processor, said program code configuring the computing system for:
registering the network-enabled controllers with the system, the network-enabled controller:
i. communicating with the system through a home router;
ii. being associated with a public network address;
maintaining active a communication link between the system and the registered network-enabled controller, the communication link being maintained active by a periodic transmittal of signals over the communication link to the system by the registered network-enabled controller;
performing a failure detection operation to detect a potential failure in connection with the communication link, wherein detecting the presence of the potential failure includes monitoring the communication link to detect an absence of signals within a time delay;
in response to detection of the potential failure in connection with the communication link, initiating a failure advisory process in connection with the registered network-enabled controller corresponding to the communication link for which the potential failure was detected, wherein said failure advisory process includes issuing a notification conveying the potential failure.

60. A non-transient computer readable storage medium as defined in claim 59, wherein issuing the notification includes transmitting an electronic message conveying the potential failure over a computing network to a remote computing device.

61. A non-transient computer readable storage medium as defined in claim 60, wherein the failure advisory process includes:
a. accessing a memory medium to obtain contact information associated with the registered network-enabled controller corresponding to the communication link for which the potential failure was detected, the contact information being associated with a person to contact when a potential failure in connection with the communication link is detected;
b. transmitting the electronic message to the remote computing device using the obtained contact information.

62. A system for facilitating monitoring of a network-enabled controller for a bathing unit, said system including one or more processors programmed for:
registering the network-enabled controller with the system, the network-enabled controller:
i. communicating with the system through a home router;
ii. being associated with a public network address;
maintaining active a communication link between the system and the registered network-enabled controller, the communication link being maintained active by a periodic transmittal of signals over the communication link to the system by the registered network-enabled controller;
performing a failure detection operation to detect a potential failure in connection with the communication link, wherein detecting the presence of the potential failure includes monitoring the communication link to detect an absence of signals within a time delay;
in response to detection of the potential failure in connection with the communication link, initiating a failure advisory process in connection with the registered network-enabled controller corresponding to the communication link for which the potential failure was detected, wherein said failure advisory process includes issuing a notification conveying the potential failure.
